(19) United States
(12) Patent Application Publication
(10) Pub. No.: US 2026/0320692 A1
(43) Pub. Date: Oct. 15, 2026

(54) TIME FABRIC AND CLOSE DISPERSION FOR DETERMINISTIC REPLAY AND AI-ASSISTED RESOURCE OPTIMIZATION

(71) Applicant: Thomas Hecht, Cambridge, MA (US)

(72) Inventor: Thomas Hecht, Cambridge, MA (US)

(21) Appl. No.: 19/458,984

(22) Filed: Jan. 26, 2026

Related U.S. Application Data
(63) Continuation-in-part of application No. 19/051,264, filed on Feb. 12, 2025, now Pat. No. 12,561,745.

(51) Int. Cl. G06Q 40/06; G06N 3/048; G06N 3/0495; G06N 3/063; G06N 3/084; G06N 3/09; H04L 9/32

(52) U.S. Cl. CPC G06Q 40/0631; G06N 3/048; G06N 3/0495; G06N 3/063; G06N 3/084; G06N 3/09; H04L 9/3297

(57) ABSTRACT

A computing platform normalizes operational events across multiple accounting timebases and disperses period-close processing to reduce end-of-period spikes while preserving auditability. A time fabric maps canonical event records to synchronized calendar labels including at least one non-Gregorian calendar and generates period identifiers. For each period boundary, the platform produces a receipt binding a canonicalization hash, a state root over canonical records, and a trusted time-stamp token. A close dispersion engine decomposes a close workflow into micro-stages represented as a directed acyclic graph and schedules micro-stages across calendar slots based on resource constraints, optionally booking auditor-capacity windows under an atomic scheduling protocol. The platform generates deterministic replay manifests and witness bundles enabling verification of a closed state root. In embodiments, the platform is coupled to an AI-driven optimization kernel that predicts efficient configurations of ownership and usage rights in assets or entitlements and actuates changes while maintaining continuous access.

### CROSS-REFERENCE TO RELATED APPLICATIONS

This application is a continuation-in-part of U.S. patent application Ser. No. 19/051,264, filed Feb. 12, 2025, entitled “Artificial Intelligence Systems and Methods for Efficient Use of Assets,” published as U.S. Patent Application Publication No. US 2025/0182211 A1 on Jun. 5, 2025. The entire disclosure of the foregoing application is incorporated herein by reference for all purposes to the extent permitted by 37 C.F.R. § 1.57.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

The following U.S. patent application publications and applications (and any U.S. patents issuing therefrom) are incorporated by reference in their entireties for all purposes to the extent permitted under 37 C.F.R. § 1.57:
US 2016/0225081 A1 (published 2016-08-04)
US 2021/0295432 A1 (published 2021-09-23)
US 2023/0214920 A1 (published 2023-07-06)
US 2024/0330865 A1 (published 2024-10-03)
US 2025/0005638 A1 (published 2025-01-02)
US 2025/0005670 A1 (published 2025-01-02)
US 2025/0156959 A1 (published 2025-05-15)
US 2025/0182211 A1 (published 2025-06-05).

Any incorporation by reference is not an admission that any incorporated reference constitutes prior art with respect to the present disclosure. Applicant expressly disclaims any admission that the cited subject matter is well-understood, routine, or conventional.

No essential material is incorporated by reference except as permitted under 37 C.F.R. § 1.57(d). If any incorporated material is deemed inconsistent with the present disclosure, the present disclosure controls. Incorporation by reference is not used as a substitute for satisfying 35 U.S.C. § 112. In addition, no incorporation by reference is intended by way of a hyperlink or other form of browser-executable code.

No computer program listing appendix, sequence listing, or large tables are submitted via ASCII plain text files or XML files as part of this application unless expressly identified in an Application Data Sheet or a separate incorporation statement.

### STATEMENT REGARDING PRIOR DISCLOSURES BY THE INVENTOR OR A JOINT INVENTOR

Not applicable.

### BACKGROUND OF THE INVENTION

The background is provided to place the disclosed technology in an illustrative context and is not an admission that any described reference, practice, technique, system, or product is prior art, is analogous art, or is well-understood, routine, or conventional. Applicant expressly disclaims any such admission.

Technical Field. The present disclosure relates to computer-implemented systems for (i) time normalization and calendar labeling of operational events across multiple accounting and regulatory timebases, (ii) distributed workflow orchestration for period-close processing, audit coordination, and year-end or cycle-end operations, and (iii) machine-verifiable evidence generation including deterministic replay manifests, period boundary receipts, and cryptographic anchors. In embodiments, the disclosure further relates to AI-assisted resource optimization systems that allocate ownership and/or usage rights in assets, entitlements, work units, and other resources to maximize collective economic benefit while reducing transaction count, recomputation, and reliance on human or institutional intermediaries.

Background. Many operational stacks—payroll, benefits, accounting, banking, insurance, marketplace settlement, and compliance—depend on periodic boundaries (e.g., month-end close, quarter-end reporting, annual audits, tax-year boundaries, and plan-year resets). Conventional implementations tend to concentrate compute, reconciliation, and human review into a small number of period-end windows, creating predictable peaks (“close spikes”) that increase error rates, latency, and audit cost.

These peaks are worsened when multiple calendar schemes must be reconciled, such as Gregorian month labels, ISO week years, retail 4-4-5 calendars, 52/53-week fiscal years, plan years, and cross-jurisdiction effective dates. The same underlying event stream may be relabeled multiple times across systems, often with ad hoc transformations that are difficult to replay deterministically. As a result, control testing, audit sampling, and investigation of a disputed posting frequently depend on manual work and on intermediaries that reconcile inconsistent ledgers and timebases.

Conventional workflow-management systems may provide checklists, task assignments, or reconciliations, but often treat time as a single calendar and rely on manual roll-forwards and after-the-fact explanations to resolve cutoffs, late postings, and cross-ledger inconsistencies. These approaches typically do not provide a deterministically replayable execution package that binds period boundaries, configuration states, and ordered receipt sets to trusted time anchors in a way that is independently verifiable across different calendar views.

Human intermediaries and institutional intermediaries (e.g., management layers, brokers, auditors, agents, and third-party administrators) persist in part because underlying systems cannot safely coordinate across time, policy, and jurisdiction boundaries in a machine-verifiable way. There remains a need for repeatable, scalable architectures that (a) improve computer operation via time normalization, deterministic replay, and evidence generation, (b) reduce wasted computation and transaction count via compression and coordinated execution, and (c) enable governed automation (including AI-assisted optimization) without losing auditability.

### BRIEF SUMMARY OF THE INVENTION

In one aspect, the disclosure provides a computing platform implementing a repeatable optimization loop that evaluates an asset or resource configuration, predicts more efficient alternatives, and actuates changes to ownership and/or usage rights while preserving continuity of access. The platform ingests utilization transaction data, supplemental datasets, and policy constraints, and uses one or more AI/ML engines to generate a predicted most-efficient-use vector and to select an ownership entity or wrapper structure that increases expected collective economic benefit.

In another aspect, the platform implements a Time Fabric module that (i) maps raw timestamps to a canonical time axis, (ii) assigns multiple deterministic calendar labels (e.g., fiscal, plan-year, jurisdictional), (iii) disciplines time via secure time synchronization and trusted time sources (including optional hardware-assisted timestamping and remote attestation of the time base), and (iv) issues period boundary receipts anchored to trusted time-stamp tokens and/or external ledger anchors, thereby enabling deterministic re-labeling and deterministic replay and verification of close states across calendar views.

In another aspect, the platform implements Close Dispersion by decomposing a close, reconciliation, and/or compliance process into micro-stages that are scheduled across operational periods using constraint-aware optimization and atomic booking of capacity windows. The platform generates booking receipts, deterministic replay manifests, and privacy-preserving witness bundles so that distributed close states can be replayed and verified (including by stateless verifiers) with reduced reliance on manual intermediaries and with reduced end-of-period peak load.

The disclosed architectures provide technical improvements in distributed scheduling, deterministic replay, and cryptographically verifiable auditability, including time normalization, deterministic state commitments, receipt canonicalization, proof-carrying compression, and governance controls that improve computer system reliability, reduce resource consumption, and enable secure interoperability across heterogeneous calendar, jurisdictional, and policy regimes.

### BRIEF DESCRIPTION OF THE SEVERAL VIEWS OF THE DRAWING

Unless otherwise indicated, the drawings are for purposes of illustration only and are not drawn to scale. Like reference numerals designate like elements throughout the drawings.

FIG. 1 illustrates a distributed system overview including a time fabric, close-dispersion scheduler, deterministic replay module, and an AI/ML engine coupled to asset and ownership data stores.

FIG. 2 illustrates an example time fabric pipeline that maps canonical events to multiple calendar labels and generates period identifiers, period boundary receipts, and trusted time-stamp tokens.

FIG. 3 illustrates an example close dispersion DAG that decomposes a close workflow into micro-stages, schedules micro-stages across calendar slots, and optionally books auditor-capacity windows under an atomic scheduling protocol.

FIG. 4 illustrates generation and verification of deterministic replay manifests, witness bundles, and verification of a replayed state root against an anchored period boundary receipt.

FIG. 5 illustrates settlement compression and correlation identifier propagation, including linking a settlement manifest to a proof-of-netting receipt and reconciling external confirmations to internal receipt graphs.

FIG. 6 illustrates receipt canonicalization and proof-carrying compression, including conversion of receipts into canonical encodings, construction of a Merkle DAG over dependencies, and generation of witness bundles for stateless verification.

FIG. 7 illustrates trusted time discipline, including secure clock synchronization (e.g., secure NTP/NTS and/or PTP), trusted timestamp authority tokening, and anchoring of period boundary receipts to trusted time sources.

FIG. 8 illustrates follow-the-sun close dispersion and auditor capacity orchestration across time zones, including pre-booked capacity windows, atomic scheduling/commit protocols, and exception-driven reallocation.

FIG. 9 illustrates an optional redactable receipt ledger architecture with immutable hash-chained headers and redactable payload references under quorum-controlled redaction, together with public redaction proofs.

FIG. 10 illustrates a continuous control testing and control-to-receipt (C2R) mapping pipeline that emits control coverage artifacts and binds them to run manifests for deterministic replay.

FIG. 11 illustrates model compression and governance, including quantization calibration, sparsity-preserving updates (e.g., functionally-invariant path updates), model/version attestations, and fallback-to-rulepack execution when governance constraints trigger.

FIG. 12 illustrates mapping of vertical applications (e.g., month-end close, payroll cycles, plan years, tax years, and policy cutovers) onto the same time fabric, receipt spine, and deterministic replay primitives.

FIG. 13 illustrates an optional token-to-bank rail adapter using ISO 20022 bindings and atomic commit semantics across rails, including generation of a settlement manifest that binds token receipts and bank receipts under a shared correlation identifier.

FIG. 14 illustrates an optional regulator-as-node evidence extraction interface that generates regulator-ready extract packages from receipt graphs, including selective disclosure and redaction receipts.

FIG. 15 illustrates an optional compliance query engine (e.g., ReceiptQL) and runtime policy enforcement, including content-addressed evidence templates, deterministic re-execution of templates over anchored state roots, and enforcement of feature TTL/model exclusion during inference or scheduling.

FIG. 16 illustrates an example AI/ML hardware acceleration architecture, including memory-stored neural-network weights and activations, static quantization to low-precision representations, and an ASIC neural network accelerator executing activation functions and sparsity-preserving updates.

FIG. 17 illustrates an example geospatial dataset shard migration architecture, including distributed memory devices in different data centers, shard caching and prefetch, and shard movement based on a latency-or-cost heuristic.

### DETAILED DESCRIPTION OF THE INVENTION

The following detailed description is provided to describe illustrative embodiments and implementations. The embodiments described herein are not intended to be limiting. Various modifications and combinations will be apparent to those skilled in the art. Unless otherwise specified, the described components, data structures, and flows may be implemented in different combinations and may be distributed across one or more computing systems.

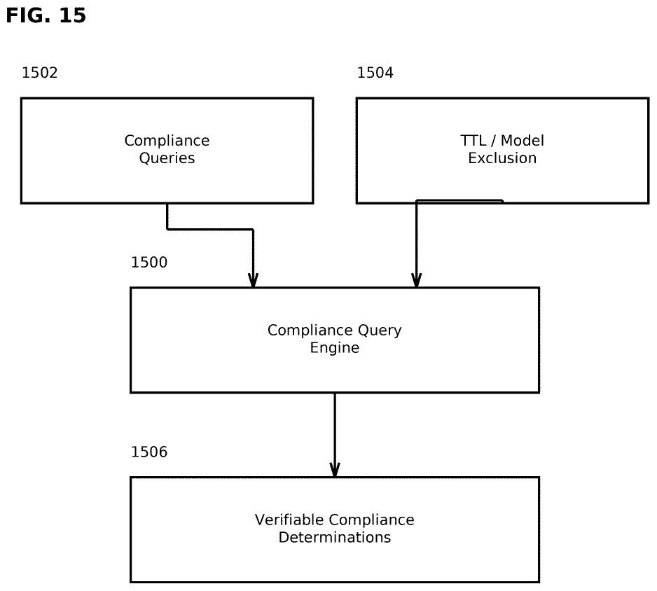

Referring to FIG. 15, a compliance query engine 1500 executes compliance queries 1502 over receipt graphs and manifests, enforces feature TTL and model exclusion constraints 1504 during inference or scheduling, and outputs verifiable compliance determinations 1506 bound to receipts.

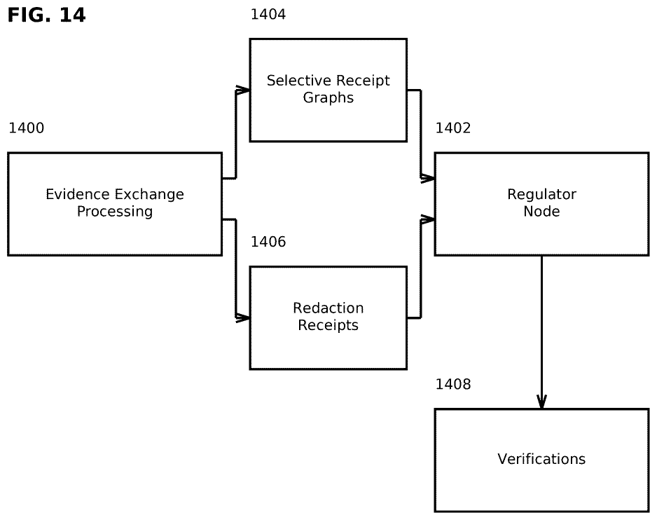

Referring to FIG. 14, regulator-as-node evidence exchange processing 1400 supports a regulator node 1402 that receives selectively disclosed receipt graphs 1404, validates redaction receipts 1406, and performs verifications 1408 without requiring direct access to underlying raw transactional data.

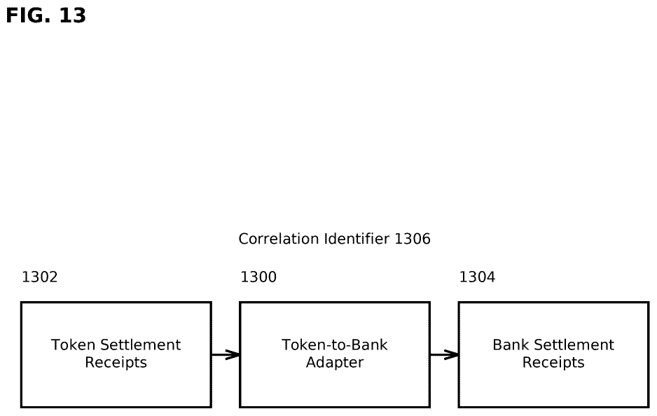

Referring to FIG. 13, a token-to-bank rail adapter 1300 optionally maps token settlement receipts 1302 to bank settlement receipts 1304 under a shared correlation identifier 1306, enabling dual-rail settlement with consistent audit evidence across token and traditional payment networks.

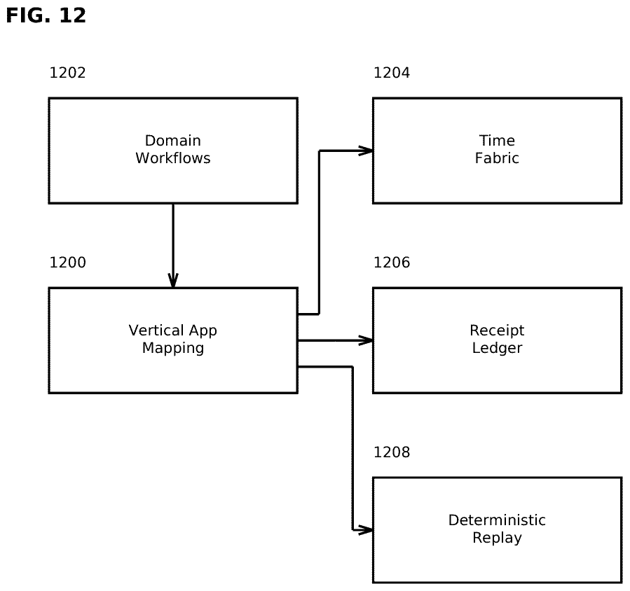

Referring to FIG. 12, vertical application mapping 1200 couples one or more domain workflows 1202 (e.g., payroll, benefits, tax, insurance, healthcare eligibility, or asset usage) to shared primitives including the time fabric 1204, receipt ledger 1206, and deterministic replay 1208.

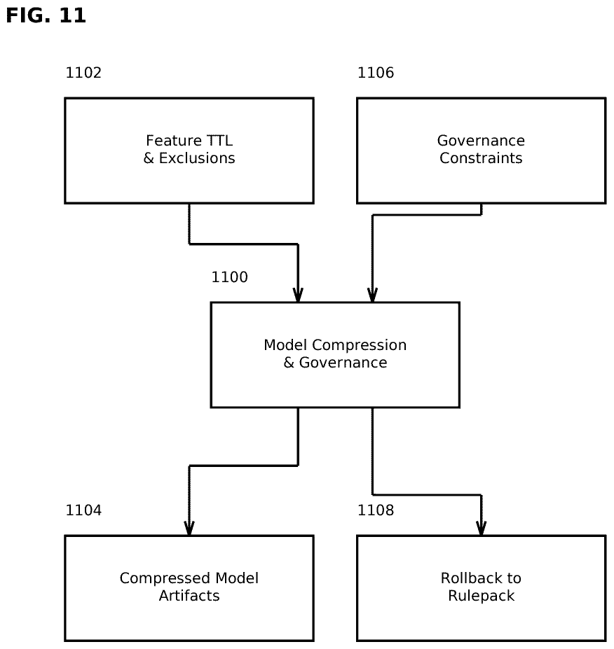

Referring to FIG. 11, model compression and governance processing 1100 manages feature TTLs and exclusion policies 1102, produces compressed model artifacts 1104, enforces governance constraints 1106, and triggers rollback-to-rulepack execution 1108 when model trust or compliance conditions are not satisfied.

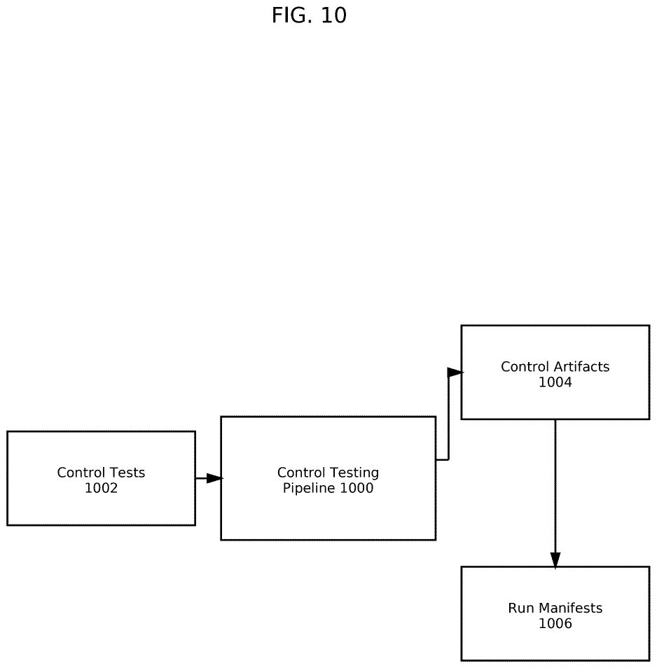

Referring to FIG. 10, continuous control testing processing 1000 distributes control tests 1002 across operational periods, generates control artifacts 1004, and binds results to run manifests 1006 such that control evidence is replayable and independently verifiable.

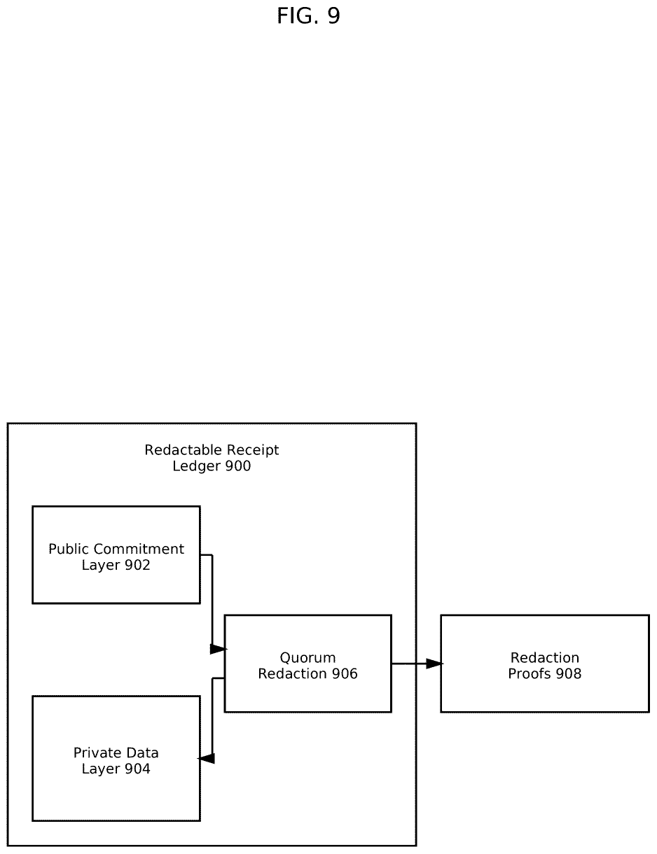

Referring to FIG. 9, a redactable receipt ledger architecture 900 supports selective disclosure by maintaining a public commitment layer 902 and a private data layer 904, performing quorum-controlled redaction 906, and generating redaction proofs 908 that preserve verifiability of non-redacted assertions.

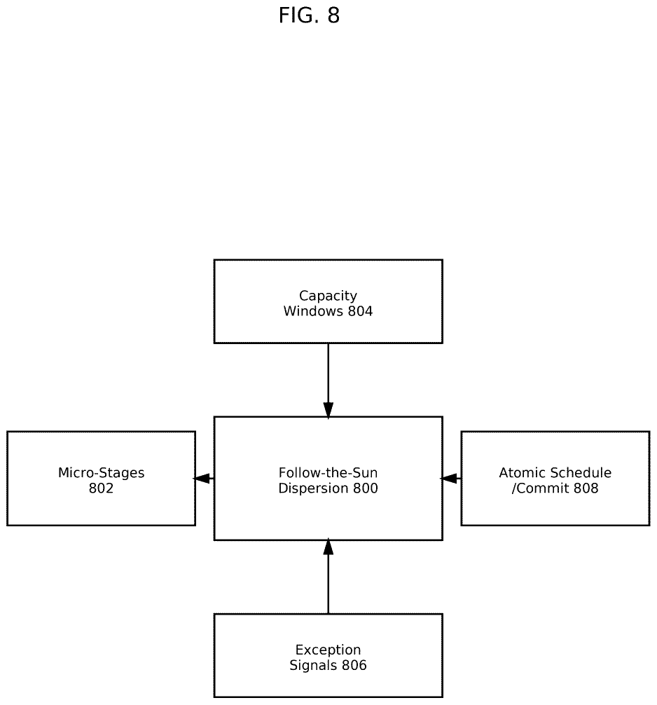

Referring to FIG. 8, follow-the-sun close dispersion processing 800 reassigns micro-stages 802 across geographies and time zones based on capacity windows 804, exception signals 806, and atomic schedule/commit protocols 808, while preserving deterministic replay and receipt-based auditability.

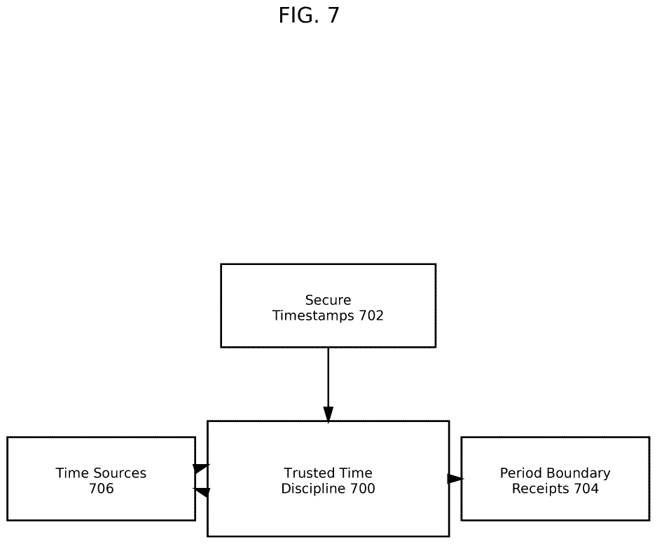

Referring to FIG. 7, trusted time discipline processing 700 obtains secure timestamps 702 (e.g., via a trusted timestamp authority, secure element, HSM, or enclave), computes and anchors period boundary receipts 704, and optionally cross-checks multiple time sources 706 to detect drift and preserve replay integrity.

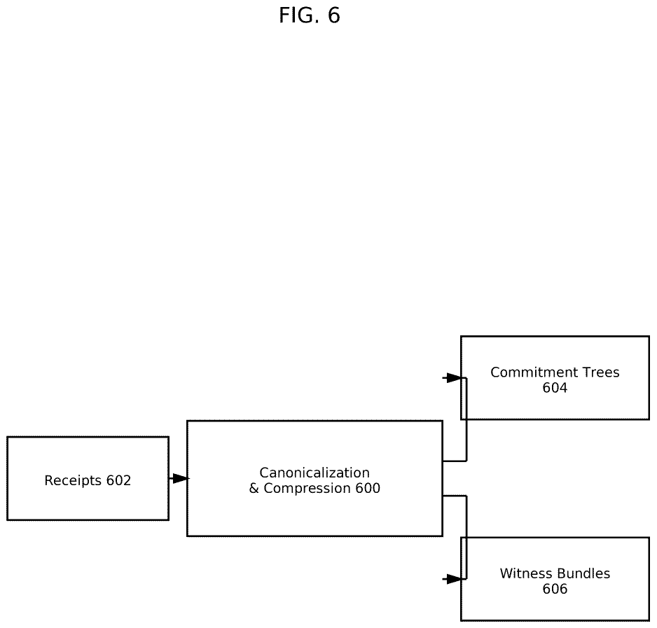

Referring to FIG. 6, receipt canonicalization and proof-carrying compression processing 600 deterministically serializes receipts 602, constructs commitment trees 604, and generates witness bundles 606 that permit stateless verification of aggregates, assertions, and scheduling outcomes without disclosure of underlying sensitive data.

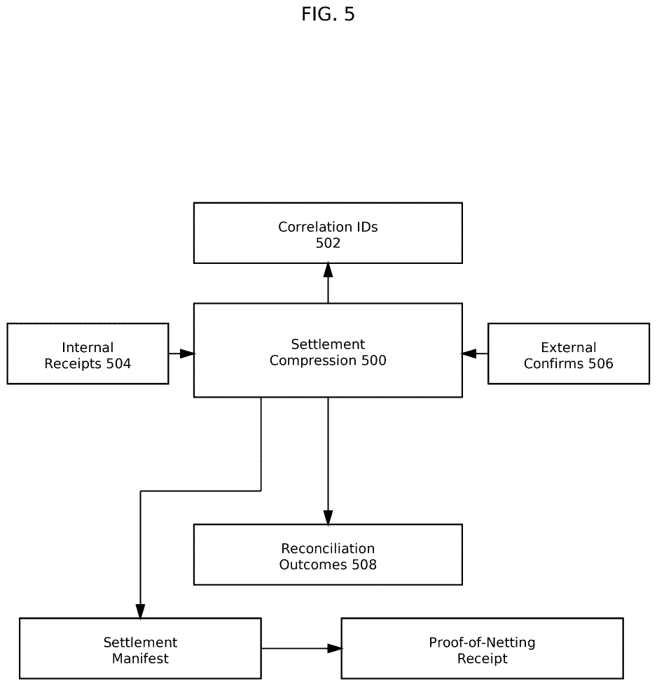

Referring to FIG. 5, settlement compression processing 500 generates correlation identifiers 502 that bind (i) internal postings and receipts 504, (ii) external confirmations 506, and (iii) reconciliation outcomes 508, thereby enabling compact verification of net effects and reducing redundant transaction steps.

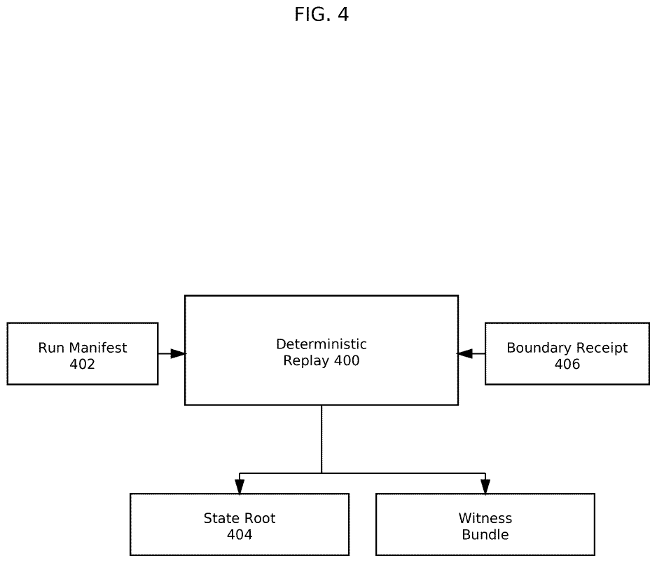

Referring to FIG. 4, deterministic replay processing 400 generates a run manifest 402 capturing inputs, rulepack versions, seeds, and schedule decisions; executes the close workflow to produce a state root 404; and verifies the state root 404 against a period boundary receipt 406 to confirm that replayed results correspond to a declared cutoff and configuration.

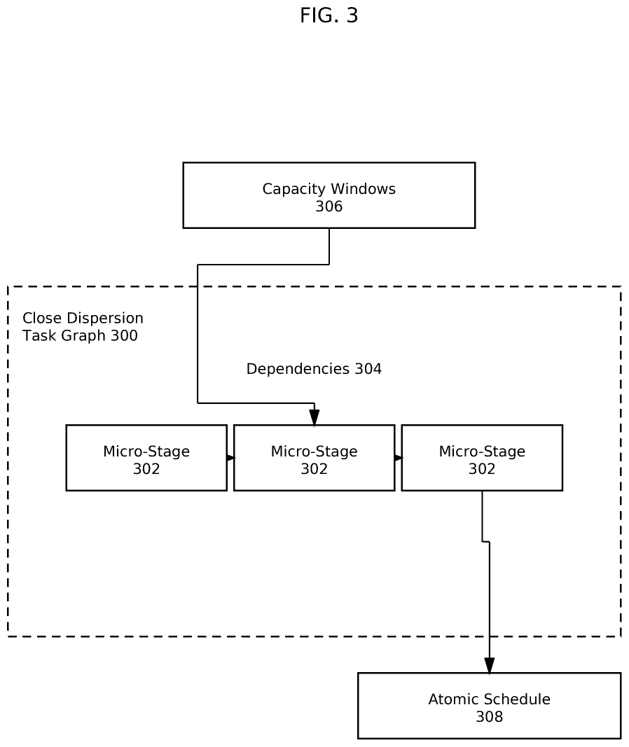

Referring to FIG. 3, an example close dispersion task graph 300 decomposes a close workflow into micro-stages 302 with dependencies 304, assigns the micro-stages 302 to auditor-and system-capacity windows 306, and commits an atomic schedule 308 that is bound to a run manifest for deterministic replay.

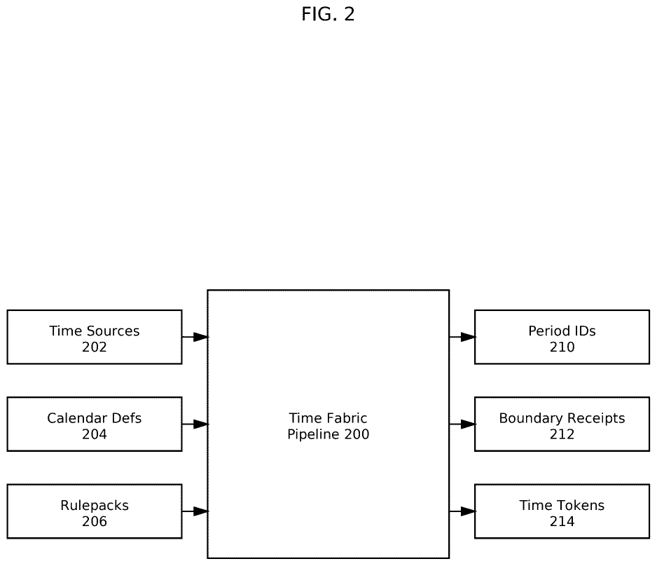

Referring to FIG. 2, an example time fabric pipeline 200 ingests time sources 202 and calendar definitions 204, applies jurisdiction-and entity-specific rulepacks 206, and produces normalized operational period identifiers 210, period boundary receipts 212, and trusted time tokens 214 that collectively support deterministic replay and verifiable period cutoffs.

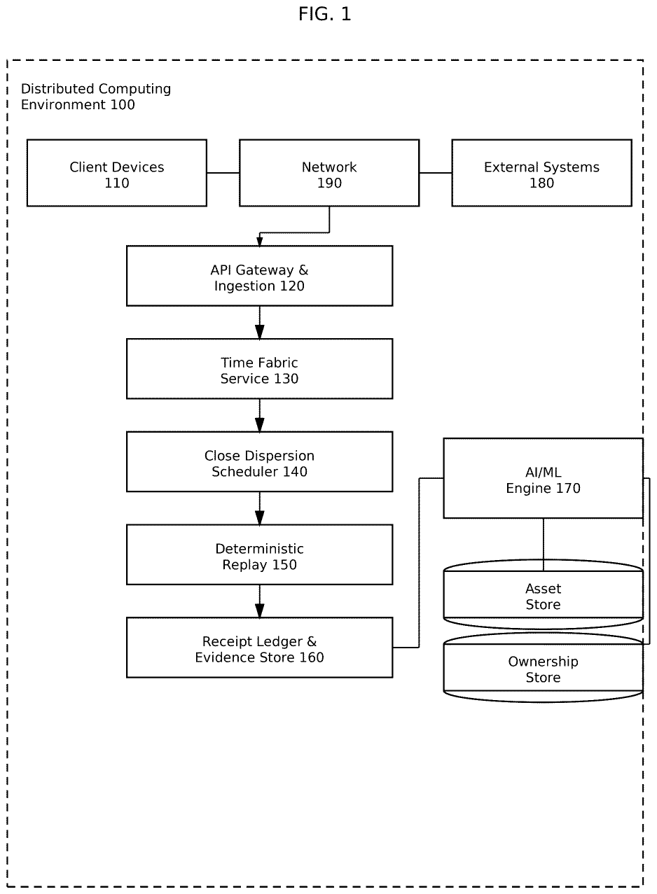

Referring to FIG. 1, an example distributed computing environment 100 includes client computing devices 110, an API gateway and ingestion layer 120, a time fabric service 130, a close dispersion scheduler 140, a deterministic replay manager 150, a receipt ledger and evidence store 160, an AI/ML optimization engine 170, and one or more external systems 180 (e.g., ERP, payroll, banking, benefits, or tax systems) coupled via one or more networks 190.

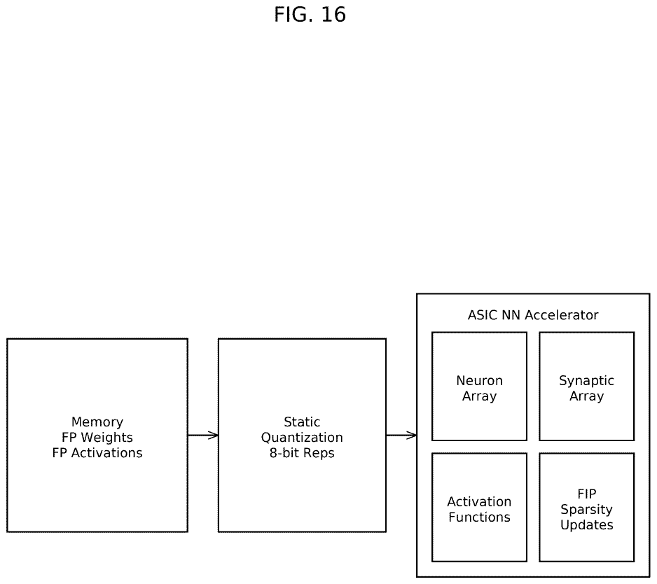

Referring to FIG. 16, an example AI/ML hardware acceleration architecture includes memory storing floating-point weights and activations, a static quantization module producing 8-bit integer representations, and an ASIC neural network accelerator with neuron and synaptic circuit arrays and circuitry operable to execute sparsity-preserving functionally invariant path updates.

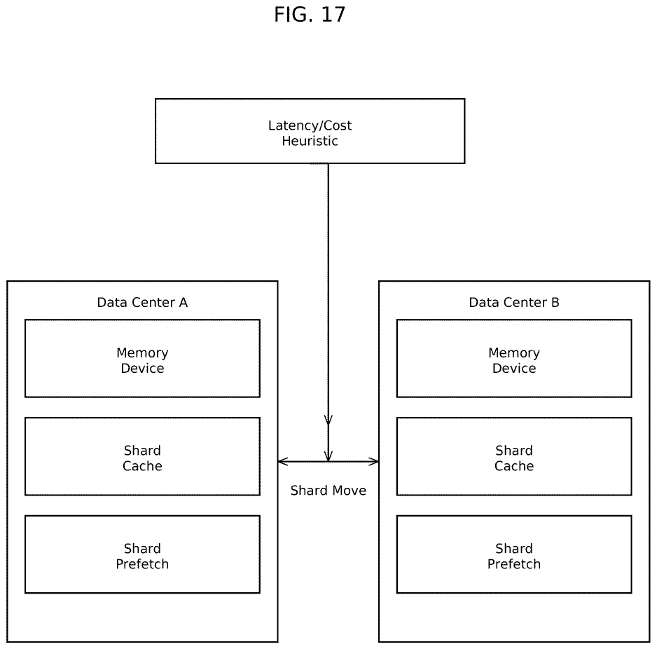

Referring to FIG. 17, the platform may migrate dataset shards among distributed memory devices in different geospatial data centers based on a latency-or-cost heuristic, including caching frequently accessed shards and prefetching anticipated shards to sustain low-latency parallel access during close cycles and deterministic replay.

### Reference to the Drawings

The present disclosure is described with reference to the accompanying drawings, in which like reference numerals denote like elements. The drawings are not necessarily to scale and are intended to illustrate selected embodiments.

### Definitions and Non-Limiting Terminology

Unless otherwise specified, the following terms are used in a non-limiting sense. ‘Asset’ includes tangible and intangible resources, rights, entitlements, obligations, work units, service capacity, or a combination thereof. An asset may be represented at any granularity, including as a parcel (e.g., time slices, usage units, fractional rights).

‘Collective economic benefit’ includes an objective function output computed by the system representing an expected aggregate utility or surplus across multiple stakeholders. In some embodiments, the objective function output is computed from one or more measurable parameters including expected cash flows, expected tax costs, expected risk costs, expected compliance penalties, expected utilization, expected latency, expected storage/compute costs, and/or expected transaction costs, and the objective function output is used by the system to rank candidate ownership entities, schedules, time-fabric configurations, or execution configurations.

In some embodiments, ‘collective economic benefit’ is computed as a weighted sum, a lexicographic score, or a constrained optimization objective. The system may record, in a receipt, the objective function value together with the weights, constraints, and component metrics used to compute the value so that the value is reproducible during deterministic replay and can be audited for rulepack compliance.

‘Ownership inefficiency’ includes a measurable divergence between (i) a predicted most-efficient-use vector for an asset and (ii) a declared, observed, or forecasted usage vector. In some embodiments, the divergence is computed using one or more distance metrics (e.g., cosine distance, Kullback-Leibler divergence, Wasserstein distance, or thresholded categorical mismatch counts) and compared to an ‘ownership-inefficiency threshold’ stored in a rulepack or policy node.

‘Operational period identifier’ or ‘period_id’ includes a canonical identifier for a period in a selected calendar configuration, including at least a calendar_id or calendar-configuration hash, a period start boundary, a period end boundary, and a label tuple (e.g., fiscal_year, fiscal_period, week_index) that is deterministically derivable from the calendar configuration and a trusted time anchor.

‘Close dispersion’ includes decomposition of a close workflow into micro-stage jobs and scheduling execution of the micro-stage jobs across multiple operational periods, capacity windows, jurisdictions, and/or time zones to reduce peak utilization while preserving auditability and deadline compliance.

‘Dispersion score’ includes a metric computed over a schedule plan that represents (i) a maximum utilization across windows, (ii) a variance of utilization across windows, and/or (iii) a penalty for late execution, and the dispersion score is stored in a run manifest together with a schedule_hash so that the schedule decision is reproducible.

‘User’ includes an individual, household, organization, device, process, or software agent that has a usage relationship, entitlement, obligation, or role with respect to an asset. ‘Ownership entity’ includes any legal or administrative wrapper capable of holding title or rights (e.g., personal ownership, business entities, trusts, cooperatives, nonprofit entities, foundation-owned operating entities, captive insurers, or other specialized wrappers).

‘Usage agreement’ includes a lease, rental, subscription, license, service entitlement, or any record granting possession or access rights that are separable from legal title or beneficial ownership.

‘Receipt’ includes a structured, signed, and/or hash-linked record that attests to an event, computation, policy decision, netting computation, classification, scheduling decision, period boundary, audit procedure, or system actuation. Receipts may be stored in an append-only ledger, a verifiable log, or other tamper-evident data structures.

‘Time fabric’ includes data structures and routines that map raw event timestamps into one or more normalized time labels (e.g., fiscal month, ISO week, retail period, plan year, benefit year) and that bind periods to trusted anchors or boundary receipts so that later re-labeling or replay is deterministic and verifiable.

‘Deterministic replay manifest’ or ‘run manifest’ includes a record that binds a set of inputs (events, configurations, rulepacks, model versions, random seeds, and/or schedule decisions) to a set of outputs (state roots, close outputs, receipts) such that replay yields the same results given the same inputs.

‘Rulepack’ or ‘rule-pack’ includes a versioned, jurisdiction-specific bundle of machine-readable policies, constraints, thresholds, templates, and precedence rules used to compile and/or gate execution; in some embodiments, receipts bind a rulepack identifier and rulepack hash used for a given decision or actuation.

‘Unit of work’ (also referred to in some embodiments as a ‘taskoid’) includes a smallest schedulable and/or compensable work parcel, such as a close micro-stage, reconciliation step, control test, or settlement leg; the unit of work may be addressed by a stable work_id and may have dependency edges, input/output schemas, and an associated rulepack reference.

‘Pay cycle’ includes a settlement and/or reporting period identified by a period_id and bounded by start/end time anchors; a pay cycle may be aligned to a payroll cadence, accounting close cadence, plan year cadence, tax year cadence, or other operational calendar schema.

‘Settlement identifier’ includes a per-cycle or per-atomic-group identifier that deterministically links requests, commitments, acknowledgments, postings, and/or confirmations across internal receipts and external rail messages; in some embodiments, the settlement identifier binds to external correlation identifiers (e.g., EndToEndId, UETR) and is preserved through the chain.

‘StateRoot’ (also referred to as state root) includes a cryptographic commitment to a state representation (e.g., a canonical event log, a ledger snapshot, a task-DAG state, and/or an aggregate table) computed using hashing, Merkleization, vector commitments, or similar techniques.

‘StateCommitmentCheckpoint’ includes a checkpoint receipt that binds (i) a stateRoot, (ii) a time label and/or period_id, and (iii) a defined inclusion rule (e.g., event_set_root) for verifying that a state corresponds to a particular window of events.

‘Witness bundle’ includes a compact evidence package sufficient to allow a verifier to validate one or more claims (e.g., a financial assertion, cutoff assertion, control assertion, or scheduling assertion) using bounded proofs and receipts without requiring access to all raw underlying data.

‘Receipt canonicalization’ includes deterministic serialization rules (e.g., stable field order, stable encoding, normalization of timestamps/time zones, and normalization of numeric precision) such that hashing and proof generation are reproducible across implementations and over time.

‘Proof-carrying compression’ includes generation of compact proofs (e.g., Merkle proofs, range proofs, inclusion proofs, and/or polynomial commitment proofs) that permit verification of aggregates or invariants while reducing the volume of disclosed raw data and/or reducing the number of reconciliation interactions.

‘Collective economic benefit’ (sometimes abbreviated as ‘CEB’) includes one or more objective functions, utility functions, or scoring functions that quantify, for a candidate allocation or scheduling decision, an expected aggregate benefit across one or more participants, assets, accounts, or constraints. In some embodiments, collective economic benefit is computed as a weighted sum or other aggregation of: (i) expected net financial value (e.g., revenue, cost reduction, avoided penalties), (ii) risk-adjusted value (e.g., volatility penalties, tail-risk measures), (iii) compliance value (e.g., reduced audit exceptions, faster remediation), (iv) operational resilience (e.g., reduced peak load, reduced manual interventions), and/or (v) fairness and distribution constraints (e.g., minimum service levels), where each component is computed from receipt-native inputs and is bound into a run manifest for determinism.

‘Ownership inefficiency’ includes a quantitative measure of divergence between (i) an observed or declared usage pattern and/or resource utilization pattern and (ii) a predicted most-efficient-use vector and/or policy-conforming target vector generated by the AI/ML engine, subject to rulepacks and constraints. In some embodiments, ownership inefficiency is computed as a distance metric (e.g., cosine distance, L1/L2 norm, earth mover's distance) between vectors, optionally adjusted by confidence scores and policy weights, and is recorded as a receipt for auditability.

‘Inefficiency threshold’ includes one or more configurable threshold values, percentile cutoffs, or adaptive decision boundaries used to determine when an ownership reassignment, scheduling reassignment, audit escalation, or other optimization action should be invoked. In some embodiments, the threshold is static; in other embodiments it is adaptive and is updated based on drift detection, risk posture, seasonality, or observed exception rates, with each threshold version hash captured in the deterministic replay manifest.

‘Close dispersion’ includes decomposition and scheduling of a closing, reconciliation, compliance, audit, or reporting process into multiple micro-stages that are executed and evidenced across a plurality of operational periods (e.g., daily, weekly, bi-weekly, monthly), such that the final close for a reporting boundary has reduced peak load, reduced exception density, and reduced reliance on manual, end-of-period interventions.

‘Dispersion score’ includes one or more metrics used to evaluate candidate dispersed schedules, including, for example: (i) peak concurrency of close tasks, (ii) cumulative work-in-progress at period boundaries, (iii) exception and rework likelihood, (iv) number of cross-period dependencies, (v) audit-capacity utilization variance, and/or (vi) deadline slack. In some embodiments, the orchestrator minimizes a dispersion score subject to constraints and records the selected score and objective weights in the run manifest.

‘Capacity window’ includes a time-bounded, capability-scoped, and optionally credential-gated availability interval provided by an auditor, control owner, automated test agent, or other resource. In some embodiments, a capacity window is represented as a signed offer, reservation token, or booking receipt that specifies a start timestamp, end timestamp, capabilities/roles, maximum parallelism, pricing/credit terms, cancellation policy, and an identifier that is linkable to a settlement identifier (e.g., EndToEndId, UETR) for downstream reconciliation.

‘Booking receipt’ includes a receipt-native record that evidences an atomic commitment (or atomic commit attempt) of one or more tasks to one or more capacity windows, including references to the relevant period identifier(s), task identifiers, parties, conflict-resolution outcomes, and cryptographic digests that bind the booking to the run manifest.

### Computing Environment and System Architecture

In some embodiments, the system is implemented as one or more computing nodes connected by one or more networks. The nodes may include on-premises servers, cloud instances, edge devices, or hybrid deployments. Each node may include processors, memory, storage, secure hardware elements, and network interfaces.

In some embodiments, the system includes a data ingestion layer that receives events and records from external systems, including but not limited to enterprise resource planning systems, accounting ledgers, payroll systems, brokerage systems, benefits administrators, tax filing systems, banking rails, identity providers, and device telemetry.

In some embodiments, the system includes a canonicalization layer that transforms incoming records into a canonical schema. Canonicalization may include schema normalization, type coercion, identity resolution, deduplication, reference resolution, and deterministic serialization for hashing and replay.

In some embodiments, the system includes an AI/ML categorization engine that operates on asset-utilization transaction data and supplemental datasets to output predicted configurations, including a most-efficient-use vector. The AI/ML engine may be implemented on general-purpose hardware, accelerated hardware, or an application-specific integrated circuit (ASIC) or other specialized compute element.

In some embodiments, the system includes an ownership-entity database storing parameters and constraints for candidate ownership entities (or other candidate structures). The system queries and ranks candidates under an objective function that maximizes expected collective economic benefit subject to constraints, and selects a top-ranked candidate for execution.

In some embodiments, the system includes a transaction execution module that encodes and executes a transaction bundle, including (i) generating, executing, and storing a conveyance record that designates a selected ownership entity as owner and (ii) generating, executing, and storing a usage-agreement record that preserves a user's access (e.g., under a lease, rental, subscription, or long-term usage agreement). In some embodiments, upon successful execution, the system dispatches an electronic alert or user-facing confirmation indicating that the ownership reassignment has been completed without interrupting user access.

In some embodiments, the system includes a time fabric module that maps event timestamps into multiple synchronized calendar labels and emits period boundary receipts that bind period identifiers to canonicalized state digests.

In some embodiments, the system includes a close dispersion orchestrator that uses the time fabric to define operational periods, schedule close tasks as micro-stages across those periods, book capacity windows, and generate deterministic replay manifests and evidence packages.

In some embodiments, the system includes a receipt ledger and replay engine that stores receipts and manifests and enables stateless verification, partial disclosure, and deterministic replay for audits and compliance checks.

In some embodiments, the system includes distributed storage and caching, including migration of dataset shards among geospatial data centers based on latency or cost heuristics to sustain parallel low-latency access.

### Canonical Event Records and State Representation

In some embodiments, each ingested record is represented as a canonical event record. A canonical event record may include: an event identifier; a source system identifier; a source timestamp; a normalized timestamp; one or more calendar labels; one or more participant identifiers; one or more asset identifiers; one or more amounts or quantities; one or more jurisdictional or policy context identifiers; and one or more cryptographic digests or signatures.

In some embodiments, the system maintains one or more state stores derived from canonical event records. State stores may include: asset state (e.g., current owner, usage agreement terms, utilization metrics), participant state (e.g., eligibility predicates, trust coefficients), policy state (e.g., rulepack versions), and ledger state (e.g., outstanding obligations, netting sets).

In some embodiments, the system computes a period state root (stateRoot) at the end of each operational period. The stateRoot may be computed over canonicalized state records, for example by hashing a deterministically ordered list of state objects or by computing a Merkle root of a Merkle tree over those objects.

In some embodiments, the system stores witness data enabling reconstruction of the stateRoot computation, including ordered object digests, inclusion proofs, and pointers to underlying event records, subject to redaction and privacy policies.

In some embodiments, a canonical event record (or receipt) has a deterministic schema including fields such as: (i) a receipt_type; (ii) a receipt_id; (iii) one or more actor identifiers; (iv) one or more asset/account identifiers; (v) one or more timestamps (raw_time, canonical_time, and/or time_source identifiers); (vi) one or more references to input receipts and/or upstream digests; (vii) a payload section containing normalized attributes; (viii) a rulepack_id and rulepack_hash; (ix) a model_id and model_hash for AI-assisted decisions; (x) an output section containing derived values (e.g., netted amounts, schedule assignments); and (xi) one or more cryptographic elements such as signatures, HMACs, Merkle paths, commitment proofs, or attestation reports. Canonical serialization is applied prior to hashing such that independent implementations produce identical digests.

In some embodiments, receipt canonicalization includes normalization of number formats (e.g., fixed-point encoding), string normalization (e.g., Unicode normalization), field ordering, and deterministic handling of optional/nullable fields, thereby reducing false mismatches during replay and verification.

In some embodiments, to ensure deterministic ordering of canonical event records across distributed ingest nodes, the system assigns each event a monotonic event_index derived from a hybrid logical clock (HLC), Lamport timestamp, or vector clock combined with a node identifier and a per-node sequence number. The event_index is used to deterministically sort events when computing the period state root and when generating deterministic replay manifests.

In some embodiments, where two or more events share the same normalized timestamp, the system applies a deterministic tiebreak rule that sorts events by one or more of: (i) the event_index, (ii) a receipt_id hash, (iii) a source-system priority encoded in a rulepack, and/or (iv) a stable ordering of account/asset identifiers. This ensures that stateRoot computations remain stable across replay and across independent verifiers.

In some embodiments, the system enforces idempotency by requiring each event to carry an idempotency_key (e.g., a stable hash over a source message identifier and selected payload fields) and by rejecting, collapsing, or deterministically merging duplicates. In some embodiments, any merge rule applied (e.g., last-write-wins by event_index, additive merge for commutative fields, or compensation events) is recorded in the run manifest so that replay reproduces the same result.

In some embodiments, the state commitment computed for a period is generated using a Merkle tree (e.g., Merkleization of receipts), and witness bundles include Merkle inclusion proofs. In other embodiments, vector commitments (e.g., polynomial commitments) are used to commit to an ordered set of receipts or state elements. In some embodiments, a fallback Merkle commitment is also computed for interoperability and for verifiers that do not implement a vector-commitment verifier.

In some embodiments, the receipt ledger is implemented as an append-only log with hash chaining and/or Merkle-tree checkpoints analogous to transparency logs, such that a verifier can audit append-only consistency and detect equivocation. In some embodiments, a regulator-view node or auditor-view node can subscribe to checkpoint receipts and request witness bundles without accessing all underlying raw data.

### Time Fabric: Multi-Calendar Labeling and Time Normalization

In some embodiments, the time fabric module maps raw timestamps into multiple synchronized calendar labels. For example, the same event may be labeled with: (i) a Gregorian label (year, month, day, quarter), (ii) an ISO week label (ISO year, week, weekday), (iii) a retail 4-4-5 label (period number, week number in period), (iv) a custom fiscal label (fiscal year, fiscal period), and/or (v) plan-year labels (benefit year, tax year, enrollment window).

In some embodiments, the time fabric includes a calendar configuration object that specifies the calendar schemas to be maintained. The configuration object may include time zone policies, daylight saving time handling policies, leap second handling policies, and period boundary rules for each calendar view. The configuration object may be hashed to produce a calendar-configuration hash, which may be used as an input to generate operational period identifiers.

In some embodiments, the calendar configuration object includes explicit rules for daylight saving time transitions (gap/fold handling) that are bound to a specific time zone database version, and includes a leap-second handling policy (e.g., step, smear, or TAI-mapped time) so that normalization yields deterministic canonical_time values across deployments and across replay.

In some embodiments, the time fabric maintains both (i) a wall_clock_time component used for human-facing reporting and statutory calendars and (ii) a monotonic_time component used for ordering and determinism. The system may combine these using a hybrid logical clock (HLC) such that a canonical event ordering can be reproduced even when wall clocks drift or when events are ingested out of order.

In some embodiments, the system records time-source provenance and error bounds in one or more time attestation receipts, including identifiers of NTP servers, PTP grandmasters, hardware timestamping devices, and/or trusted time-stamp authorities. The error bounds may be compared to a rulepack threshold, and period boundary receipts may be rejected, quarantined, or require quorum approval when the error bounds exceed the threshold.

In some embodiments, the time fabric deterministically generates an operational period identifier (period_id) for each operational period. The period_id may be generated by hashing a tuple that includes a calendar-configuration hash and a representation of the period boundary (e.g., start and end timestamps, or a period sequence number).

In some embodiments, operational periods are defined independently of statutory reporting periods. For example, operational periods may follow a 4-4-5 cadence, while statutory reporting must be produced for Gregorian months and quarters. The time fabric provides deterministic mappings between operational periods and reporting periods, enabling aggregation or re-labeling without losing traceability.

In some embodiments, the system emits a period boundary receipt at each operational period end boundary. The period boundary receipt may bind the period_id, start time, end time, calendar-configuration hash, a stateRoot, one or more digests of included events, and a previousCheckpointId (or similar field) that references a prior period boundary receipt and/or a state commitment checkpoint. The receipt may be digitally signed and may include or reference a trusted timestamp token, a blockchain anchor, or other external time attestation, and may be stored in an append-only receipt ledger or event log to support consistency auditing.

In some embodiments, to reduce susceptibility to local clock manipulation or time drift, the platform hardens time acquisition by synchronizing one or more system clocks using secure time synchronization protocols (e.g., Network Time Security (NTS) for NTP, or Precision Time Protocol (PTP)) and by cross-checking time against multiple independent time sources. The platform may store time-source attestations (e.g., time-source identifiers, synchronization error bounds, and freshness indicators) as part of the PeriodBoundaryReceipt or as a referenced receipt so that a verifier can evaluate the reliability of the time base used when anchoring the period boundary.

In some embodiments, the trusted time-stamp token is an RFC 3161-compliant Time Stamp Token (TST) issued by a Time Stamping Authority (TSA). The platform submits a cryptographic digest (e.g., a hash of a PeriodBoundaryReceipt, a stateRoot, or an ordered digest list of covered receipts) to the TSA and receives a digitally signed token that binds the digest to a TSA-provided time value. The token (or a hash thereof) is stored in, or referenced by, the PeriodBoundaryReceipt to provide evidence that the covered state existed no later than the TSA-provided time and to enable third-party verification without exposing underlying sensitive data.

In some embodiments, period boundary receipts enable a verifier to prove that events were included in the correct time window and that backdating or omission would change the stateRoot or the event digests. This provides a technical mechanism to enforce ‘cutoff’ integrity without manual spreadsheet reconciliation.

In some embodiments, the time fabric implements a cutoff fence that assigns late-arriving events to an appropriate period and emits an exception receipt when an event's source timestamp and ingestion timestamp straddle a period boundary in a way that violates configured cutoff rules. The exception receipt may include remediation actions, such as generating an adjustment event in a subsequent period.

In some embodiments, the time fabric supports secure time sources. For example, the time fabric may bind trusted anchors to outputs from secure time synchronization protocols, secure timestamp authorities, or trusted execution environments, thereby reducing time-based tampering attacks.

In some embodiments, secure time synchronization includes use of Network Time Security (NTS) for the Network Time Protocol (NTP), where an authenticated key-establishment exchange (e.g., NTS-KE) is used to derive keys for authenticated NTP packets, thereby reducing man-in-the-middle and spoofing risk for time sources used in cutoff receipts. In some embodiments, multiple independent time sources are queried and a byzantine-resilient selection routine (e.g., median-of-N sources with outlier rejection) is used, and the selected time-source set and rejection statistics are bound into the period boundary receipt.

In some embodiments, for low-latency local networks, the time fabric uses Precision Time Protocol (PTP) and/or hardware-assisted time stamping (e.g., network interface controllers with hardware time-stamp support) to produce verifiable sub-millisecond ordering of events within a data center or edge environment. In some embodiments, the hardware time-stamp configuration (device identifiers, firmware digests) is included in an attestation report referenced by the period boundary receipt.

In some embodiments, the time fabric is location-aware and includes geo/jurisdiction tagging for events and for operational periods. For example, an event may be labeled with a jurisdiction_id, timezone_id, or regulatory calendar identifier, and the time fabric maps the event to multiple labeled timelines (e.g., local legal day boundaries, tax residency boundaries, plan-year boundaries). In some embodiments, location evidence (e.g., GPS, cellular, network-region attestations, or device-bound attestations) is captured as receipts and is used to enforce data-residency policies, to support follow-the-sun dispersion scheduling, and to ensure consistent application of jurisdiction-specific cutoff rules.

In some embodiments, trusted time and/or location evidence is protected using secure hardware (e.g., TPMs, secure elements, TEEs) and remote attestation. For example, a time-source component can produce an attestation report binding (i) a measurement of the executing code, (ii) configuration values (e.g., NTS server set, PTP grandmaster id), and (iii) a monotonic counter value, and the attestation report hash is stored in the receipt ledger such that a later verifier can confirm the integrity of the time base used for period boundary receipts.

The platform's Time Fabric ingests raw events (timestamped in UTC) and relabels them into multiple business calendars in parallel. For example, transactions can be mapped into Gregorian months, 4-4-5 retail periods, 52/53-week fiscal years, or even the International Fixed calendar. Each calendar view is continuously updated as data arrives. At each period boundary (e.g. month-close, quarter-end, etc.), the system emits a trusted timestamp receipt anchored by a secure time source (e.g. RFC 3161 TST). These anchor receipts bind events to fixed reporting periods and provide an auditable “checkpoint”.

By running flows on these multiple labeled timelines, organizations can smoothly compare or aggregate data across different accounting schemes (retail vs. standard fiscal year) without clock skew. The trusted anchors serve two key purposes: (1) they allow downstream analytics to stitch together data consistently across calendar systems, and (2) auditors can later verify that each event was recorded in the correct window. In essence, the Time Fabric automates period transformations and guarantees the integrity of time-based accounting.

Parallel Calendars: Supports retail 4-4-5 cycles, standard 12-month, ISO week years, or any custom schema. This flexibility enables retail companies, for instance, to align reporting with store calendar weeks while still reconciling against Gregorian quarters.

Anchor Receipts: At each period boundary, the system produces a signed timestamp certificate. For example, when March 31 23:59 UTC is reached, an anchor receipt is logged; any transactions in that period can be cross-checked against that anchor. These receipts are recorded in manifests so auditors can prove “no data was omitted or backdated” in any reporting period.

Auditability and Smooth Operations: The Time Fabric enables consistent smoothing of workload peaks. Because each event carries the anchor evidence, downstream processes (like closing books or audits) can be scheduled with confidence that time labels are consistent and tamper-evident.

This innovation ensures that time-handling is declarative and verifiable, rather than ad hoc. It follows best practices (e.g. use of NTS/PTP for secure time) and solves real-world accounting needs (e.g. multi-jurisdiction fiscal reporting). By binding every timestamp to a trusted anchor, the platform creates a fully auditable “Time Fabric” for any operational calendar.

### Close Dispersion: Micro-Staged Closing Cycles Across Operational Periods

In some embodiments, the close dispersion orchestrator defines one or more classes of close tasks that would traditionally be performed at month-end, quarter-end, or year-end. Close tasks may include reconciliation, accrual calculation, confirmation requests, exception investigation, audit sampling, financial statement assembly, control testing, and evidence packaging.

In some embodiments, close tasks are decomposed into micro-stage tasks that can be executed earlier and more frequently. For example, rather than reconciling all transactions at month-end, the system may reconcile subsets of transactions weekly or daily and record intermediate reconciliation receipts.

In some embodiments, the orchestrator represents close tasks as a directed acyclic graph (DAG) of dependencies. Each node may include: a task identifier; required inputs; dependency edges; resource requirements (CPU, memory, human hours, specialized roles); expected duration; deadline; and output receipts.

In some embodiments, the orchestrator computes a dispersion schedule that assigns micro-stage tasks to operational periods so as to minimize peak load while meeting reporting deadlines. The dispersion schedule may optimize a cost function that includes at least: peak-to-mean compute utilization; peak-to-mean human capacity utilization; lateness penalties; and risk penalties associated with deferring certain tasks.

In some embodiments, the orchestrator uses the time fabric's parallel calendar labels to shift internal processing boundaries without changing statutory outputs. For example, a quarter may be internally processed as 4-4-5 operational periods, while still emitting quarter-end close outputs on the statutory quarter-end date. Intermediate micro-stage tasks may be completed earlier, reducing the final crunch.

In some embodiments, dispersion decisions are recorded in a run manifest or deterministic replay manifest. The manifest may list tasks executed in the period, inputs used, outputs produced, exceptions encountered, and the period boundary receipt that anchors the run.

In some embodiments, the orchestrator supports ‘follow-the-sun’ execution, where tasks are allocated to teams or compute regions based on time zones to enable a 24-hour continuous workflow. The orchestrator may record handoff receipts that bind task outputs to subsequent task inputs across regions.

In some embodiments, the orchestrator supports an audit capacity booking mechanism, in which external auditors or internal assurance teams publish capacity windows, and the system reserves windows in advance. Capacity reservations may be represented as capacity tokens and recorded as booking receipts (also referred to as audit reservation receipts) that bind reserved slot identifiers, applicable period_id(s), and a reservation digest and/or schedule hash to support deterministic replay and auditability. The orchestrator may treat reserved windows as hard constraints to reduce rescheduling risk.

In some embodiments, the orchestrator supports privacy-preserving capacity marketplaces in which participants reveal limited attributes before commitment and reveal additional details after commitment. Matching decisions may be recorded in match receipts and linked to booking receipts.

In some embodiments, dispersion of close cycles improves system performance by smoothing compute and staffing peaks. For example, by shifting computations earlier and spreading tasks across periods, the system reduces peak CPU usage, reduces overtime, reduces settlement retry rates, and improves mean-time-to-detect anomalies.

### Calendar Dispersion For Auditor Orchestration (PvP-like Capacity Windows)

The calendar dispersion technique staggers periodic workloads to flatten peaks and coordinate audits. Rather than having all business units close books on the same quarter-end, each unit's “close” is offset (e.g. different weeks of the quarter), enabled by the Time Fabric. Simultaneously, the organization's auditor pre-books audit windows throughout the year-these are mutual “capacity windows” locked in advance (akin to payment-vs-payment (PvP) exchanges). Neither party can override these slots, ensuring dedicated audit attention. Because the schedule is opaque, sensitive details of what will be audited can remain confidential while still reserving slots.

As illustrated in the calendar dispersion schedule (the figure), the system computes metrics on throughput smoothing. For instance, it can generate indices of workload distribution (showing how evenly financial and audit tasks are spread over time) versus historical “end-of-quarter spike” profiles. Every dispersed close event and audit window is then sealed with a timestamp and included in an audit manifest for that period. This allows later verification of exactly which data set was reviewed in each audit slot. this method reduces resource bottlenecks: analysts and auditors have a steady, predictable cadence rather than alternating feast-or-famine cycles. It also enables billing or surplus allocation models (e.g. deferring audit costs or credits based on smoothing gains).

By pre-arranging “PvP-like” time slots, calendar dispersion ensures continuous audit readiness and maximizes resource efficiency. It is an innovative application of temporal scheduling: the platform's orchestration engine treats auditor time as a first-class reserveable resource, much like processing cores or funds. This goes beyond conventional fixed calendar scheduling, offering policy-driven timing and verifiable event anchors.

In some embodiments, dispersion is expressed as a set of schedule windows and eligibility constraints compiled into a deterministic schedule plan that can be replayed and audited; the schedule plan may include (i) window start/end, (ii) eligible task classes, (iii) eligible participant roles, (iv) capacity limits, and (v) atomic commit semantics.

In some embodiments, the orchestrator optimizes an objective function that trades off dispersion score, deadline risk, dependency slack, compute cost, and exception risk; the optimizer may be implemented using integer programming, constraint programming, heuristic search, reinforcement learning, or a hybrid approach, and the chosen optimization configuration is bound into a run manifest receipt.

Scheduling algorithm (non-limiting example). In some embodiments, the close dispersion orchestrator executes a constraint-aware scheduling routine that takes as input: (i) a set of close tasks, each task having an identifier, dependency edges, a duration estimate, a deadline, and one or more capability predicates; (ii) one or more capacity windows (e.g., auditor windows, automation windows, compute windows), each capacity window having a start time, end time, maximum parallelism, and a capability predicate; (iii) a time fabric mapping that yields canonical time and one or more calendar labels for each candidate slot; and (iv) an objective configuration defining dispersion-score weights. The routine outputs a schedule assignment mapping tasks to time slots and capacity windows, where the assignment is recorded as a booking receipt and is bound into the run manifest.

In some embodiments, the scheduling routine includes building a directed acyclic graph (DAG) of close tasks (CloseTaskDAG) where nodes correspond to tasks and edges correspond to data dependencies evidenced by receipts (e.g., task B consumes a reconciliation receipt produced by task A). The orchestrator computes earliest-start and latest-finish bounds for each task using the time fabric and deadlines, and prunes candidate windows that violate capability predicates.

In some embodiments, the orchestrator computes a dispersion score for candidate schedules using, for example: peak concurrent tasks per period, total number of task context switches, expected exception probability (inferred from historical receipts and model outputs), and auditor utilization variance. In some embodiments, the orchestrator selects a schedule that minimizes the dispersion score subject to constraints; in other embodiments, the orchestrator uses a multi-objective optimization where a Pareto front is computed and a selection rule is applied (e.g., lexicographic or weighted selection).

Atomic booking protocol (non-limiting example). In some embodiments, once a candidate schedule is selected, the orchestrator performs an atomic commit across one or more external resources (e.g., auditor calendars, test agents, compute clusters). The atomic commit can be implemented using a two-phase commit protocol or a saga pattern. For example: (1) RESERVE: the orchestrator sends reserve requests for each capacity window and obtains signed reservation tokens; (2) COMMIT: if all reservations succeed and the schedule hash matches, the orchestrator sends commit requests that convert reservation tokens into booking receipts; (3) ROLLBACK/COMPENSATE: if any reservation fails, the orchestrator cancels reservations and emits compensation receipts. Reservation tokens, commit acknowledgements, and compensation receipts are hash-linked to the deterministic replay manifest such that a verifier can reproduce the schedule decision and confirm no silent rescheduling occurred.

Conflict resolution and fallback. In some embodiments, if a constraint violation is detected (e.g., auditor window revoked, late adjustment posted, or a dependent task output receipt fails verification), the orchestrator generates a conflict receipt describing the violation and invokes a deterministic resolution policy. Non-limiting examples include: (i) selecting an alternative capacity window that satisfies the same capability predicate; (ii) substituting an automated control test agent for a human auditor where permitted by policy; (iii) re-partitioning the task into sub-tasks with narrower evidence scope; (iv) deferring the task to a later micro-stage and adjusting downstream tasks; or (v) escalating to a manual exception queue. The selected resolution and the rulepack used are recorded in the run manifest.

Example pseudo-code (illustrative, not limiting):

Input: tasks T, capacity_windows W, time_fabric F, objective_weights Ω1. Normalize each task deadline and each capacity window boundary using F→canonical_time2. Build CloseTaskDAG from T using receipt-linked dependencies3. For each task t ∈T: compute candidate_slots(t)={w∈W|capability_predicates(t)⊆capabilities(w) and w within deadline bounds}4. Search/optimize for assignment A: T→candidate_slots minimizing dispersion_score(A, Ω)5. Compute schedule_hash=H(canonical_serialize(A)∥Ω∥rulepack_hash∥model_hash)6. Execute atomic booking protocol using schedule_hash to obtain booking receipts7. Emit run_manifest={schedule_hash, booking_receipt_ids, period_boundary_receipt_id, inputs_digests}Output: run_manifest, booking_receipts, and any exception receipts

Optimization formulation (illustrative, not limiting). In some embodiments, the scheduling routine is expressed as a mixed-integer optimization. For each micro-stage task t and each candidate window w, a binary decision variable x(t, w) indicates whether task t executes in window w. Constraints may include: (i) each task scheduled exactly once; (ii) precedence constraints derived from the CloseTaskDAG; (iii) per-window capacity constraints for compute resources and/or human reviewer capacity; (iv) audit-capacity constraints that require selected tasks to occur within reserved auditor windows; (v) jurisdictional constraints derived from the time fabric and rulepacks; and (vi) fairness constraints that cap utilization contributions by a business unit or tenant. The objective may minimize a dispersion_score that combines peak utilization, variance of utilization, and lateness penalties, optionally with stability penalties for moving tasks.

Schedule stability and incremental re-optimization. In some embodiments, the orchestrator produces an initial schedule_plan for a horizon (e.g., multiple weeks) and then incrementally re-optimizes as new events arrive (late postings, new transactions, detected control failures). The system may apply a change_cost term that penalizes modifications to already-booked tasks and may require a two-phase commit for schedule updates so that dependent parties can rely on reserved windows. Each schedule update may emit a RescheduleReceipt that references a prior schedule_hash, includes a new schedule_hash, and includes a canonical diff or patch so that deterministic replay can reproduce the update without ambiguity.

Exception handling and deadline guarantees. In some embodiments, if an exception (e.g., data-source outage, variance anomaly, unavailable auditor window, or policy cutover) prevents execution within a planned slot, the system generates an ExceptionReceipt and invokes a fallback policy recorded in a rulepack. Non-limiting fallbacks include: (i) switching to a conservative rule-only close for affected micro-stages; (ii) deferring the micro-stage to the next permissible window while emitting a cutoff adjustment receipt; (iii) reducing scope by executing only tasks necessary to produce a verified minimum reporting package; and/or (iv) escalating to a human approver with a recorded approval receipt. The exception path is bounded, receiptized, and replayable.

Follow-the-sun handoff (illustrative). In some embodiments, the orchestrator executes micro-stages in multiple jurisdictions and transfers work-in-progress between regions. A HandoffReceipt may bind: (i) the stateRoot at handoff time; (ii) the set of pending tasks and their dependencies; (iii) the schedule_hash for the receiving region; and (iv) an attestation of time-source accuracy for the handoff boundary. The receiving region may validate the handoff by recomputing a digest over the pending-task set and validating the bound stateRoot. This prevents silent rescheduling and preserves determinism across regions.

In some embodiments, close dispersion is applied not only to financial statement assembly but also to other periodic processes such as tax compliance, benefits enrollment rollovers, insurance renewals, payroll settlement reconciliation, and any workflow with periodic cutoffs. The same time fabric and deterministic replay mechanisms enable repeatable and scalable application across industries while keeping the core technical kernel consistent.

### Deterministic Replay, Evidence Packages, and Auditability

In some embodiments, each operational period produces a deterministic replay manifest that allows deterministic reconstruction of (i) the inputs that were processed, (ii) the configuration and rulepack versions applied, (iii) the model versions and seeds used, and (iv) the resulting stateRoot and outputs. The manifest may be stored in the receipt ledger and may be hash-linked to prior manifests.

In some embodiments, deterministic replay manifests support partial verification. For example, a verifier may validate stateRoot transitions, receipt signatures, and inclusion proofs without needing access to raw personally identifiable information. Selective disclosure may be implemented through redacted receipts, predicate proofs, or external credential presentations.

In some embodiments, the system generates interim close evidence packages throughout the year. An evidence package may include: a close window receipt summarizing period totals; exception receipts for anomalies; and references to supporting receipts (e.g., confirmations, reconciliations). By year-end, a large portion of audit procedures may already be completed and evidenced.

In some embodiments, if management records late adjustments after a close boundary, the system generates an adjustment manifest and an adjustment receipt. The receipt may reference the affected period boundary receipt and record the reason code and policy justification for the adjustment, thereby preserving audit integrity and determinism.

In some embodiments, a stateless verifier can validate that a close output is consistent with the period boundary receipt and deterministic replay manifest by recomputing digests, validating signatures, and verifying that the reported aggregates match recomputed aggregates from included event digests.

Worked example (non-limiting): deterministic replay for a dispersed close. In some embodiments, for an operational period P (e.g., ‘2026-03’ month close, plus daily micro-stages), the system performs the following: (1) INGEST: ingest raw transactions and control evidence events (bank feeds, invoices, payroll, device telemetry) and emit canonical receipts; (2) NORMALIZE TIME: map each receipt timestamp through the time fabric to obtain canonical_time and calendar labels (Gregorian month, fiscal 4-4-5 week, plan-year), and emit a PeriodBoundaryReceipt for each applicable boundary; (3) BUILD TASK GRAPH: build a CloseTaskDAG using receipt references (e.g., reconciliations depend on bank-statement receipts); (4) SCHEDULE: compute a dispersed schedule and perform atomic booking to obtain booking receipts; (5) EXECUTE: execute tasks (human and/or automated) and emit output receipts (reconciliation receipts, control-test receipts, adjustment receipts), each output receipt referencing input receipts and the rulepack/model versions used; (6) COMMIT STATE: at cutoff, compute a stateRoot for the period by canonicalizing and committing to the set of receipts and key derived aggregates; (7) PACKAGE EVIDENCE: generate a witness bundle that includes inclusion proofs for a selected set of receipts sufficient to validate targeted assertions (e.g., ‘all bank accounts reconciled’, ‘all controls executed’) without disclosing all underlying data; and (8) EMIT RUN MANIFEST: emit a deterministic replay manifest binding together period identifiers, schedule_hash, booking_receipt_ids, rulepack_hashes, model_hashes, stateRoot, and hashes of any external attestations.

In some embodiments, a verifier replays by retrieving the run manifest and referenced receipts, re-executing canonical transformations in the order specified by the manifest, and recomputing the stateRoot and any derived aggregates. If the recomputed values match the manifest, the verifier can conclude that (i) the schedule decisions, (ii) task executions, and (iii) cutoff state were derived from the referenced inputs under the referenced rulepacks/models, without hidden manual edits or undisclosed rescheduling.

In some embodiments, deterministic replay is supported even in the presence of late-arriving information by emitting explicit adjustment receipts that are assigned to a subsequent operational period according to cutoff rules. The run manifest for the original period remains stable, and the run manifest for the subsequent period includes adjustment receipts and references to the prior period's boundary receipt, enabling a complete, auditable chain across periods.

End-to-end deterministic replay flow (illustrative, not limiting): Input: canonical_receipts R, period_id P, rulepack RP, execution_config C1. Canonicalize: serialize each receipt r in R into canonical bytes; compute receipt_hash(r)=H(bytes(r)); enforce idempotency rules.2. Order: deterministically sort receipts using canonical_time plus event_index tiebreaks.3. Commit: compute event_set_root =MerkleRoot(receipt_hash(r1) through receipt_hash(rN)) or another accumulator over the ordered receipts.4. Execute: apply RP and C deterministically to the ordered receipts to update a ledger_state; emit derived receipts as needed.5. Snapshot: compute stateRoot=H(canonical_serialize(ledger_state)) or a MerkleRoot over canonical state records.6. Anchor: generate a PeriodBoundaryReceipt binding P, a calendar_config_hash, event_set_root, stateRoot, and cutoff metadata; request a trusted time token and attach or reference a token digest.7. Manifest: generate a ReplayManifest binding the PeriodBoundaryReceipt, a rulepack_hash, a code_build_id, a container_image_digest, one or more model_hashes and random seeds, a schedule_hash, and one or more input digests.8. Package: generate a WitnessBundleReceipt referencing inclusion proofs and a minimal evidence set needed for verification. Output: ReplayManifest, PeriodBoundaryReceipt, and WitnessBundleReceipt.

In some embodiments, the ReplayManifest pins the exact execution environment that produced the close outputs, including one or more of: a container image digest; a deterministic build identifier; a cryptographic suite identifier; a hardware or enclave attestation report; a random-seed set; and an ordered list of input digests. In some embodiments, the system uses these pinned values to reproduce execution in a sandboxed verifier environment and to prevent drift between the reported close and the audited close.

In some embodiments, the ReplayManifest includes one or more fields selected from: manifest_id; period_id; calendar_config_hash; event_set_root; stateRoot; derived_aggregate_digests; cutoff_fence_metadata; rulepack_hash; model_hashes and random seeds; code_build_id; container_image_digest; schedule_hash; booking_receipt_ids; time_attestation_token_hash; signing_key_id; and pointers to underlying receipts and witness bundles (e.g., content-addressed URIs or receipt identifiers).

In some embodiments, verification is performed by a stateless verifier that: (i) validates signatures on the ReplayManifest and PeriodBoundaryReceipt using referenced key identifiers; (ii) validates the trusted time token or time-source attestation; (iii) reconstructs a minimal ledger_state using the witness bundle and rulepack(s); (iv) recomputes stateRoot and any asserted aggregates; and (v) compares recomputed digests to the anchored digests. Any mismatch may trigger generation of a DiscrepancyReceipt that identifies the divergent subgraph and the implicated inputs.

In some embodiments, deterministic replay supports partial replay and selective disclosure. For example, a verifier may request a witness bundle limited to a cut set of the receipt graph (e.g., receipts contributing to a specific aggregate line item) together with inclusion proofs that the cut set is included in the event_set_root and that the aggregate digest is consistent with the anchored stateRoot. This allows verification of specific assertions without exposing unrelated transaction details.

### AI/ML Engine Details and Continual Learning

In some embodiments, the AI/ML engine is implemented using a neural network whose weights and activations are stored in memory, for example as 32-bit floating-point values. To reduce storage footprint and improve inference efficiency, the system may statically quantize weights and activations, for example to 8-bit integers, and may use specialized low-precision arithmetic hardware.

In some embodiments, the AI/ML engine is implemented on an application-specific integrated circuit (ASIC) that includes an array of neurons and synaptic circuits configured to perform weighted computations and activation functions. In some embodiments, each neuron comprises a register (e.g., storing an activation or accumulator), a processing element (e.g., multiply-accumulate circuitry), and at least one input, and each synaptic circuit includes a memory storing a synaptic weight that couples at least two neurons such that neurons are connected to one another via synaptic circuits. The ASIC may include circuitry configured to execute a functionally invariant path (FIP) algorithm that updates network weights along differential-geometry paths so as to preserve learned behavior while increasing sparsity.

In some embodiments, the system applies supervised learning using labeled datasets and a backpropagation algorithm to minimize a loss function (e.g., a mean squared error loss function) between predicted outcomes and actual outcomes, iteratively refining network weights until an error rate falls below a predefined threshold to improve generalization on new, unseen data. In some embodiments, the system may further apply reinforcement learning to adapt policies based on observed outcomes, such as improved utilization or reduced cost.

In some embodiments, the system preserves operational safety by gating model outputs. For example, low-confidence predictions may trigger human review, or the system may fall back to rulepack-only determinations. Model identifiers and governance artifacts may be recorded in receipts so that later audits can determine which model versions influenced which decisions.

In some embodiments, continual learning occurs as new asset-utilization data arrives. The system may update models while preserving prior behavior using the FIP algorithm, enabling adaptation without catastrophic forgetting. This supports repeated optimization loops as conditions change (usage drift, market changes, policy changes).

In some embodiments, the quantization process includes (i) selecting a quantization scheme (e.g., symmetric or asymmetric; per-tensor or per-channel; static or dynamic), (ii) calibrating scale and zero-point parameters using a calibration dataset, and (iii) converting floating-point weights and/or activations to lower-precision representations (e.g., 16-bit, 8-bit, 4-bit, ternary, or binary) while bounding an error metric (e.g., mean squared error, KL divergence, or task loss delta).

In some embodiments, the system uses mixed-precision inference and/or training, wherein different layers or paths use different precisions based on sensitivity, and stores a quantization configuration receipt that binds model_id, layer identifiers, selected precision, calibration dataset digest, and resulting error bounds.

In some embodiments, the functionally invariant path (FIP) algorithm increases sparsity while preserving learned behavior by updating network parameters along a constrained path in parameter space; for example, weight updates may be projected onto a manifold defined by invariance constraints such that the function output on a reference set remains within an error bound while a sparsity objective increases.

In some embodiments, the system implements deterministic model evaluation as part of replay by binding a model snapshot (weights, quantization parameters, and inference code hash) into the deterministic replay manifest so that AI outputs used for scheduling, classification, or selection can be reproduced or audited.

In some embodiments, the system maintains dataset shards and feature stores across geospatial data centers and migrates shards based on latency, cost, and/or compliance constraints; shard migration events may be recorded as operational receipts, and prefetching/caching routines may be tuned based on observed access patterns during close cycles.

In some embodiments, the AI/ML engine includes one or more neural networks comprising an input layer, one or more hidden layers, and an output layer. Non-limiting examples of activation functions used in hidden layers include rectified linear units (ReLU), sigmoid functions, hyperbolic tangent functions, and/or gated linear units. In some embodiments, the network is trained using supervised learning with backpropagation and gradient-based optimization (e.g., stochastic gradient descent, Adam), and a training receipt records a model architecture identifier, initialization seed, optimizer parameters, and the resulting model_hash to support deterministic replay of inference outcomes.

In some embodiments, the AI/ML engine additionally or alternatively includes gradient-boosted decision trees, random forests, logistic regression, support vector machines, graph neural networks, or sequence models (e.g., transformers) to infer: (i) expected exception likelihood for close tasks, (ii) predicted runtime distributions for scheduling, (iii) anomaly scores for control evidence streams, and/or (iv) predicted most-efficient-use vectors for assets. The selected model class and hyperparameters can be versioned and referenced in run manifests and receipts.

In some embodiments, the specialized compute element executing inference and/or training includes an ASIC, GPU, TPU, FPGA, or a heterogeneous accelerator pipeline. For example, inference may run on a GPU while receipt canonicalization and hashing run on a CPU, and cryptographic verification runs on a secure enclave or HSM-backed service. The compute configuration (device ids, firmware versions) can be captured in attestation receipts to support nonrepudiation and reproducibility.

In some embodiments, quantization and compression of model parameters is combined with proof-carrying compression, where a verifier can confirm that a quantized model is within a specified error bound of a baseline model (e.g., via calibration-set digest and reported error metrics), and the error bound and calibration digest are recorded in the run manifest. This improves storage footprint and deployment latency while preserving auditability.

This figure depicts runtime enforcement of feature TTL and model exclusion during inference, scoring, or scheduling decisions.

In one embodiment, an inference gateway resolves an AllowedFeatureSet for a given request context by evaluating FeatureTTLReceipts and ModelExclusionReceipts against current time proofs, jurisdiction, consent state, and purpose. The gateway rejects disallowed features, substitutes permissible alternatives, and records the final feature set hash in an InferenceGateReceipt.

### Ownership-From-Usage Separation and Transaction Compression

In some embodiments, the system separates ownership from usage by executing a conveyance that transfers legal title (or other ownership rights) to a selected ownership entity while preserving a user's usage rights via a usage agreement. The system stores executed records and ensures that user access is not interrupted, even when ownership is reassigned to a newly selected entity, and may dispatch an electronic alert to the user confirming continuity of usage following an ownership reassignment.

In some embodiments, the system computes a benefit-sharing parameter representing surplus or savings generated by the reconfiguration. The benefit-sharing parameter may be redistributed to the user, used to fund future transactions, or allocated according to governance rules.

In some embodiments, the system compresses multi-leg transaction flows by netting obligations among participants and settling only residuals. Netting decisions may be recorded in proof-of-netting receipts that show gross vectors, offsets applied, exclusions (no-net justifications), and final net obligations.

In some embodiments, transaction bundles are executed atomically across one or more rails. For example, the system may coordinate payroll deductions, benefit premiums, and brokerage settlements so that no party executes unilaterally. Correlation identifiers may be propagated across rails to enable deterministic reconciliation and replay.

In some embodiments, compression also includes reducing interaction points. For example, rather than routing changes through broker workflows, the system may encode policy constraints and automatically actuate compliant changes, emitting receipts suitable for audit, thereby disintermediating manual intermediaries while improving traceability.

### Security, Integrity, and Privacy-Preserving Verification

In some embodiments, receipts and manifests are digitally signed and hash-linked. Key management may be implemented using hardware security modules, trusted execution environments, or other secure enclaves. The system may maintain a zero-trust posture in which each component authenticates and authorizes requests based on least privilege.

In some embodiments, period anchors are bound to trusted time sources and timestamp attestations. This reduces the ability to backdate events or to manipulate cutoff boundaries. In some embodiments, timestamp tokens or other time attestations are stored as part of period boundary receipts.

In some embodiments, privacy is preserved by storing only predicate proofs or selective disclosures in receipts. For example, a receipt may record that a regulatory safe harbor test passed without storing the raw wage or health information used to compute it. Receipts may reference externally issued credentials presented with selective disclosure.

In some embodiments, the system supports content credentials for outbound reports, notices, and filings. A content-credential receipt may bind an outbound document digest to underlying manifests, policy rulepacks, and time anchors, enabling downstream verification that the document was generated by an authorized system process.

In some embodiments, the system uses a key management service that maintains one or more hierarchical key structures, including per-tenant or per-organization keys and per-period signing keys. The system may rotate signing keys on a schedule (e.g., per quarter) and may bind a key identifier and key-policy identifier into each receipt and manifest so that a verifier can validate signatures against the correct public key set and can detect use of stale or revoked keys.

In some embodiments, receipt and manifest signatures are produced using threshold or quorum approval, such as an M-of-N threshold signature policy for period boundary receipts or redaction receipts. For example, a period boundary receipt may be considered valid only if it carries signatures from a preparer key and an independent attestation key, with the signing policy encoded in a rulepack and reproduced during deterministic replay.

In some embodiments, the system uses secure transport for receipt propagation and verifier queries, including mutual transport layer security (mTLS) between platform nodes and between the platform and external verifiers. Session identifiers, certificate fingerprints, and/or channel-binding values may be included in receipts to support nonrepudiation of inter-node handoffs.

In some embodiments, where trusted execution environments are used, the system may capture a remote attestation report that binds a measured software stack (e.g., enclave measurement, firmware measurement, or container image digest) to a signing key used for receipts. The attestation report may be referenced by a digest in the run manifest, enabling an external verifier to confirm that the close was computed in an approved execution environment.

In some embodiments, the platform uses threshold-signature and/or multisignature policies for one or more receipt types (e.g., PeriodBoundaryReceipt, StateCommitmentCheckpoint, RedactionReceipt), such that no single operator or system component can unilaterally forge, backdate, or redact evidence. For example, a k-of-n policy may require a quorum of (i) an organization controller, (ii) an independent audit node, and (iii) a regulator node to co-sign a boundary receipt.

In some embodiments, the receipt-signing scheme supports signature aggregation (e.g., aggregated public keys and/or aggregated signatures) to reduce storage and bandwidth while preserving verifiability. In some embodiments, the system supports Ed25519, ECDSA, and/or BLS-type aggregated signatures, and records a SignaturePolicyReceipt binding the scheme, key IDs, quorum rules, and rotation cadence to the operational period.

In some embodiments, privacy-preserving verification is implemented using zero-knowledge proof techniques. For example, the platform may generate a proof that (i) all events committed in a period satisfy a control policy, (ii) the close dispersion schedule satisfies declared capacity-window constraints, (iii) a stateRoot corresponds to a committed event set, and/or (iv) specific aggregate values (e.g., totals, risk measures) are within allowed bounds, without revealing individual underlying transaction values. In some embodiments, the platform uses range proofs, set-membership proofs, and/or succinct proof systems (e.g., zk-SNARK/zk-STARK variants) and records a ProofPolicyReceipt describing the circuit/version used.

In some embodiments, the platform uses secure multiparty computation (MPC) and/or distributed key generation (DKG) to create and control signing keys for receipts and manifests, thereby enforcing separation-of-duties controls and reducing single-point compromise risk. In some embodiments, a quorum of independent parties jointly computes a signature over a receipt digest without any single party reconstructing the private key in full.

### Redactable Ledger With Chameleon-hash Headers, Quorum Redaction & Public Proofs

To balance immutability with privacy laws (like GDPR's right-to-erasure), the platform uses a hybrid ledger: headers are immutable but payloads are redactable under strict controls. Each ledger entry has a fixed header containing the previous hash, timestamp, signatures, and a chameleon hash of the payload. The actual data payload is not stored verbatim in-chain; instead, the header holds a chameleon hash commitment and the payload is kept off-chain or encrypted. The chameleon hash is a special function that can be re-computed if one has a secret “trapdoor” key.

When a lawful redaction is required (e.g. erasing a user's personal record), a defined redaction quorum (multiple authorized keys per policy) collaborates. Using the trapdoor, they compute a new payload reference (pointing to redacted or blank data) and a new chameleon hash so that the header remains internally consistent. The immutable fields (previous block hash, timestamp, signatures) do not change; only the payload reference and chameleon-hash field are updated in-place. Immediately after this operation, the system appends a Redaction Proof to the ledger's metadata. This proof contains the original payload hash, the new hash, the identities of quorum members, the timestamp of change, and a reason code. the Redaction Proof is itself immutable and publicly verifiable.

This design means auditors and regulators can see that a record was redacted and exactly why and by whom, even though the sensitive content is gone. Anyone can verify the proof: it cryptographically links the original and new states. Unlike WORM-only storage (which cannot be altered), this approach provides controlled immutability: the chain of blocks stays intact, but payloads can be sanitized under governance. It cleanly supports “right-to-be-forgotten” without sacrificing the integrity of the audit trail. In some embodiments, the redactable ledger ensures compliance with retention and deletion laws by enabling explicit, auditable redaction operations-an improvement over traditional append-only ledgers.

Key features:

Immutable Header, Editable Payload: Every ledger record has a fixed header (hash pointers, timestamp, signature) with a chameleon-hash field. The payload itself is stored off-chain or encrypted, referenced by the header. This separation allows the payload to be changed (under key control) without disturbing the chain's integrity.

Quorum-Controlled Redaction: Redactions require agreement by a quorum of authorized parties, as specified by policy. They use the chameleon trapdoor to calculate a new payload reference and corresponding hash. Because all signers of the original header must be involved, unauthorized edits are infeasible.

Public Redaction Proofs: After redacting, the system logs a Redaction Proof on-chain. This proof includes the original and new chameleon hashes, signer IDs, timestamp, and rationale. It is tamper-evident and permanent. Auditors can retrieve this proof to see that the redaction was properly authorized and executed (even though they can no longer view the erased content).

Together, these measures satisfy both auditability and privacy. They adhere to best practices (using cryptographic receipts and secure time anchors) while addressing legal requirements: when data is “no longer necessary” or a user withdraws consent (GDPR Art. 17 conditions), the ledger can be purged of that data cleanly. Yet the chain of custody remains unbroken. This hybrid-immutable architecture is a significant innovation over pure WORM systems, yielding a ledger that is both legally compliant and verifiable by design.

The platform implements a redactable ledger combining immutable headers with editable payloads. Each ledger record has an immutable header (chained hashes, timestamps, signatures) and a redactable payload reference. Critically, the header includes a chameleon hash-a trapdoor hash of the payload that can be recomputed by authorized parties. When an approved deletion or update is required (e.g. to comply with privacy laws), a quorum of key holders uses the secret trapdoor to replace the payload pointer (for example, nullifying or moving PII to a tombstone) and recompute the chameleon hash so that the header remains consistent. In other words, the payload data can be changed without breaking the chain of hashes, but only under strict policy control and multi-signature approval.

After any authorized edit, the system appends a public Redaction Proof (or Deletion Receipt) to the ledger. This proof is an immutable log entry recording details of the change: the original hash, the new hash/pointer, the identity of the redacting quorum, timestamp, and a reason code (e.g. “GDPR Article 17 erasure”). For auditors, the proof reveals that a redaction occurred and was properly approved, even though the original sensitive content is no longer visible. if personal data is deleted, the platform logs a Deletion Receipt stating which data was removed and under what policy. This ensures the audit trail remains intact: regulators and forensic investigators see an intentional removal event rather than inexplicable gaps. Thus, the ledger remains tamper-evident-a user can change it, but a user cannot hide that a user changed it.

Compared to traditional WORM (Write-Once-Read-Many) archives that either never delete or erase records (often by destroying encryption keys), this hybrid approach offers a cleaner solution. Here, the headers of records stay immutable and verifiable, while only the payload pointers can be updated under governance. All redactions leave cryptographic fingerprints, so one never “shoots holes” in the audit trail. In effect, the system achieves both data minimization (removing or anonymizing old PII) and accountability, enabling GDPR-style “right to be forgotten” compliance without sacrificing the ledger's integrity.

### Example Embodiments and Vertical Applications (Dependent-Claim Level)

The disclosure is intended to support a broad set of vertical applications while keeping the independent-claim kernel stable. Accordingly, the following embodiments are non-limiting examples that may be expressed as dependent-claim clusters or as separate continuations or divisionals, depending on restriction practice and prosecution strategy.

Accounting close embodiment: The system ingests ledger events from multiple business units, maps them into parallel calendar labels, and schedules reconciliation, accrual, and evidence packaging tasks as micro-stages across operational periods. Period boundary receipts anchor stateRoots at each operational period end. Deterministic replay manifests enable auditors to verify close outputs and to trace exceptions.

Audit capacity marketplace embodiment: Audit firms publish capacity windows with limited attribute disclosure. The system reserves windows and schedules audit procedures across the year. Booking receipts and match receipts provide an audit trail of capacity commitments. Follow-the-sun handoffs are supported by receipts binding task outputs across time zones.

Payroll and labor embodiment: Work is decomposed into task-level work units that may be classified as W-2 or 1099 based on rulepacks and/or ML models. Proof-of-classification receipts bind factor outcomes and rulepack hashes. Withholding and benefits eligibility are actuated per task and included in netting computations. Time fabric anchors support mid-year qualifying-event cutovers.

Benefits and healthcare embodiment: Household members across multiple employers present selective-disclosure predicates to prove eligibility and affordability constraints. The optimizer allocates premiums and credits, and nets flows when policy permits. Proof-of-benefit and proof-of-netting receipts provide auditable evidence. Time fabric anchors support open enrollment and plan-year boundaries.

ESPP and retirement embodiment: The system coordinates plan contributions, payroll deductions, and brokerage settlements as atomic bundles and may incorporate loaned-funds or cashless participation mechanisms. Period anchors and deterministic replay manifests support Form-level confirmations and audit of plan transactions.

Nonprofit and philanthropic enterprise embodiment: Assets or operating entities may be wrapped in nonprofit or foundation-owned structures subject to encoded governance constraints. The optimizer selects wrappers that maximize collective benefit while honoring policy constraints. Wrapper evaluation receipts provide auditability of wrapper selection and transitions.

Share-economy and subscription lifecycle embodiment: Assets (e.g., vehicles, housing, tools) are decomposed into time or usage parcels. Ownership of parcels may be assigned to specialized entities while usage rights are granted to users under subscriptions. Time fabric enables scheduling and reconciliation of usage across periods, and close dispersion smooths capacity and maintenance workflows.

### Implementation Notes and Variations

In some embodiments, the system implements idempotent processing and exactly-once semantics for event ingestion and task execution. Deterministic serialization and ordering rules are used to ensure that hashing and stateRoot computations are stable across replays.

In some embodiments, the system uses distributed caching and shard migration across geospatial data centers. Frequently accessed data may be cached and anticipated data may be prefetched. Shard migration decisions may be recorded in operational receipts for audit and debugging.

In some embodiments, the system integrates with one or more external ledgers or blockchains as an anchoring rail. For example, a period boundary receipt digest may be committed to an external ledger to provide additional tamper-evidence. In other embodiments, the system uses permissioned ledgers or secure timestamp authorities.

In some embodiments, the system supports multiple objective functions and constraint sets. A solver may compute a Pareto frontier among competing objectives, and the selected configuration may be recorded with explanation graphs and receipts that bind the decision to the applied rulepack and time anchors.

In some embodiments, the same time fabric and dispersion mechanisms apply beyond accounting close, including renewal cycles, compliance filings, insurance underwriting cycles, inventory cycles, and other periodic processes where workload peaks can be smoothed while preserving external reporting fidelity.

In some embodiments, receipt and manifest payloads are compressed using content-defined chunking, dictionary compression, delta encoding, columnar encoding, and/or deduplication against prior receipts, while preserving a canonical pre-image for hashing and proof generation.

In some embodiments, the system maintains separate storage tiers for (i) raw event payloads (optionally encrypted and access controlled), (ii) canonical receipt payloads, and (iii) compact proofs/witness bundles; the receipt spine and state roots allow external parties to validate correctness without retrieving raw payloads.

In some embodiments, proof-carrying compression is implemented by (i) compressing a set of receipts or payloads using a deterministic compressor (e.g., dictionary compression, delta encoding, columnar encoding, content-defined chunking), (ii) computing a commitment to the uncompressed canonical form (e.g., Merkle root over canonical receipts), and (iii) generating a decompression proof artifact. The decompression proof artifact can include, for example: a list of chunk hashes, a mapping from chunk hashes to positions, and/or a succinct proof that the decompressed output matches the committed canonical form. This enables a verifier to confirm correctness of compressed storage without requiring the platform to retain all raw uncompressed data online.

In some embodiments, witness bundles include compressed subsets of receipts plus proofs (e.g., Merkle paths, vector-commitment openings) sufficient for a verifier to validate targeted assertions. For example, a witness bundle can prove that all tasks of a specified type were executed within reserved capacity windows by including booking receipts and task output receipts and proving their inclusion under the period stateRoot, without disclosing unrelated receipts.

In some embodiments, the system supports selective disclosure in witness bundles by encrypting sensitive payload fields under attribute-based encryption or envelope encryption keys and providing verifiers with access-controlled decryption capabilities. The system can still provide public integrity proofs by committing to ciphertext hashes and including those hashes in Merkle trees or vector commitments.

In some embodiments, key material is rotated and bound to policy epochs; key rotation events are logged as receipts so that a verifier can validate which keys were authorized for a given period and can detect unauthorized or stale-key signatures.

### Technical Effects

In some embodiments, the disclosed techniques produce technical effects including: (i) reduced peak-to-mean compute utilization for period-end processing; (ii) reduced human overtime and coordination peaks; (iii) reduced settlement retries due to earlier reconciliation and pre-authorization aligned to period anchors; (iv) improved auditability through deterministic replay manifests and typed receipts; (v) reduced attack surface through fewer manual interaction points; and (vi) improved scalability of resource allocation loops across industries by maintaining a stable independent-claim kernel and expressing vertical specificity in dependent modules.

In some embodiments, time fabric normalization reduces reconciliation overhead by ensuring that time labels are derived from declarative calendar schemas and anchored at trusted boundaries, thereby reducing disputes about cutoff timing and reducing the need for manual period adjustment entries.

In some embodiments, close dispersion reduces peak compute and staffing load by distributing close micro-stages over a larger portion of the operational calendar while preserving statutory reporting deadlines; dispersion can reduce latency of downstream analytics and reduce error rates associated with time-compressed close windows.

In some embodiments, receipt canonicalization and proof-carrying compression reduce bandwidth and storage requirements for audit evidence sharing while improving security by reducing the number of copies of sensitive data and reducing the number of human touchpoints required for reconciliation.

### Receipts, Manifests, and Core Data Schemas

In some embodiments, the platform is receipt-native: each meaningful computation, scheduling decision, policy evaluation, settlement compression, or close artifact is expressed as a typed receipt stored in a verifiable log. Receipts provide (i) determinism, (ii) replayability, and (iii) stateless verifiability, thereby reducing reliance on manual intermediaries and ad hoc reconciliation.

In some embodiments, a receipt record includes: {receipt_type, receipt_id, period_id, calendar_config_hash, issuer_id, issue_time, anchor_ref, input_digests[], output_digests[], policy_refs[], model_refs[], signature}. The specific fields may vary by receipt type.

In some embodiments, a PeriodBoundaryReceipt (also referred to as a PeriodAnchorReceipt) includes at least: period_id; start_time (also referred to as periodStart); end_time (also referred to as periodEnd); calendar_config_hash (also referred to as calendarConfigurationHash); stateRoot; included_event_digest (or included_event_set_root); optional excluded_event_digest; optional cutoff_fence_parameters; a previousCheckpointId (or previous_checkpoint_id) referencing a prior PeriodBoundaryReceipt and/or StateCommitmentCheckpoint; and a signature (or signature reference). In one example, the PeriodBoundaryReceipt is encoded as a structured object having fields: {period_id, calendarConfigurationHash, periodStart, periodEnd, stateRoot, previousCheckpointId, signature}. The trusted time attestation may be implemented as a timestamp token issued by a timestamp authority, an external ledger anchor, or an enclave attestation.

In some embodiments, a RunManifestReceipt (or DeterministicReplayManifest) includes at least: manifest_id; period_id; list of task_ids executed; task_input_digests per task; task_output_digests per task; a dispersion schedule digest; a schedule seed (if randomized); rulepack hashes; model identifiers (including quantization parameters where applicable); and one or more links to PeriodBoundaryReceipts. The manifest may include a list of correlation identifiers for external messages so that cross-rail reconciliation is deterministic.

In some embodiments, close-related receipts include: (i) CloseWindowReceipt summarizing period totals and close outputs; (ii) InterimCloseEvidenceReceipt summarizing completed procedures; (iii) ExceptionReceipt for anomalies or cutoff-fence violations; (iv) TemporalSwapReceipt documenting permitted timing shifts (e.g., early inventory counts with roll-forward procedures); and (v) RollForwardReceipt documenting roll-forward computations and thresholds.

In some embodiments, settlement-related receipts include a Proof-of-Netting (PoN) receipt that records gross vectors, offsets, exclusions, and residuals; and a Proof-of-Benefit (PoB) receipt that records that a benefit or entitlement state changed (e.g., coverage active, plan contribution posted, equity purchased) and links back to underlying PoN cycles and manifests.

In some embodiments, classification-related receipts include a Proof-of-Classification (PoC) receipt that binds factor outcomes, rulepack hashes, and jurisdiction identifiers for task-level W-2/1099 determinations or other classification problems. PoC receipts may be referenced downstream by withholding computations and by close tasks.

In some embodiments, governance-related receipts include a Content-Credential Receipt (CCR) for outbound reports and filings, and optional fairness or risk budget receipts that record aggregate metrics and guardrails without storing sensitive raw attributes.

In some embodiments, receipts are stored in a Universal Receipt Ledger implemented as an append-only log with hash chaining. Each receipt may include a previous_receipt_hash pointer to form a tamper-evident chain. For scalability, the ledger may be sharded by period_id, asset_id, and/or participant_id, while still supporting cross-shard anchors through Merkle roots recorded in PeriodBoundaryReceipts.

### Receipt Canonicalization, Compression, and Witness Bundles

In some embodiments, the receipt ledger implements canonicalization and compression of receipts and dependencies to reduce audit surface area while preserving verifiability.

This figure illustrates canonicalization and compression of receipts and dependencies to reduce audit surface area while preserving verifiability.

In one embodiment, each receipt is serialized into a canonical form (stable field order, stable encoding, normalized timestamps) and stored by content hash. A compression pipeline aggregates repeated structures (e.g., common policy nodes, template subgraphs, identical witness elements) into shared commitments and indexes them via a stateless verification index.

In some embodiments, canonical serialization uses a deterministic binary or text encoding with an unambiguous canonical form. Non-limiting examples include CBOR canonical form, deterministic Protocol Buffers serialization, canonical JSON (with stable key ordering and normalized number formatting), and/or an ASN.1/DER encoding. Canonicalization rules may include: stable key ordering; explicit schema/version identifiers; normalized Unicode forms; fixed endianness; normalized floating-point (e.g., IEEE 754 with a declared rounding mode); and normalized timestamps and time zones.

In some embodiments, the compression pipeline uses dictionary-based compression over repeated receipt fields (e.g., org_id, calendar_id, rulepack_id, signer key IDs) and/or delta encoding over monotonically evolving fields (e.g., event sequence numbers, checkpoint identifiers). Non-limiting examples include LZ-family compression, entropy coding, run-length encoding, and/or domain-specific columnar compression, while recording a CompressionPolicyReceipt binding the codec version and parameters to the compressed bundle.

In some embodiments, proof objects (e.g., Merkle inclusion proofs, vector commitment proofs, timestamp tokens) are also compressed using structural compression (e.g., shared path segments for Merkle proofs) and/or aggregation (e.g., batch verification proofs), thereby reducing network cost for regulator nodes and third-party verifiers. The platform can record a ProofAggregationReceipt describing the aggregation method, batch size, and verification keys.

The index may expose multiple proof layers, such as a coarse-grained Merkle root for a batch of receipts and fine-grained membership proofs for individual dependencies. The resulting CompressionReceipt binds the original receipt set, the compressed commitments, and the recovery procedure so that an auditor can reconstruct full evidence on demand.

The resulting WitnessBundleReceipt references the bundle hash, the covered receipts, and the policy version used, and can be transported to external verifiers, auditors, or regulator nodes. In some embodiments, the generator outputs a reduced bundle by de-duplicating shared dependencies across a batch and by substituting compact commitments (e.g., KZG/Verkle commitments) for large subgraphs.

This figure depicts a regulator-as-node interface in which a regulator-operated endpoint (or on-premise RAN-box appliance) receives regulator-ready evidence extracts anchored to receipt graph commitments.

In one embodiment, the platform generates a RegulatoryExtractReceipt that maps internal receipt types to the regulator's reporting taxonomy, includes state roots for covered periods, and packages a minimal evidence set. The RAN-box verifies signatures and commitments, optionally runs policy-defined validation routines, and emits an AcknowledgmentReceipt or ExceptionReceipt.

The interface supports selective disclosure (e.g., entity-scoped extracts) and bounded redaction; any redaction or withholding is itself receiptized with a basis code so that a regulator can distinguish missing evidence from valid confidentiality constraints.

This figure illustrates a query engine that expresses evidence requirements as executable templates over the receipt graph.

In one embodiment, a compliance officer or regulator provides an EvidenceTemplate that defines required receipt classes, dependency closure rules, and acceptance predicates (e.g., “every payroll disbursement must have a verified credential, a withholding computation receipt, and a bank commit receipt”). The ReceiptQL engine compiles the template into a query plan, executes it against the receipt index, and emits a ComplianceReportReceipt and/or MissingEvidenceReceipts that identify specific gaps.

Because templates are content-addressed and versioned, the same query can be rerun deterministically over the same state root to reproduce prior results and to validate that later changes did not retroactively alter historical compliance outcomes.

### Deterministic Replay Engine and Stateless Verification

In some embodiments, deterministic replay is achieved by enforcing canonicalization and ordering rules at ingestion, by storing deterministic replay manifests for each operational period, and by anchoring each period boundary to an immutable digest (stateRoot) and/or time attestation.

In some embodiments, the replay engine reconstructs a period's state by: (a) retrieving the period boundary receipt and the associated manifest; (b) retrieving canonical event digests (or full events, subject to access control); (c) applying rulepacks and policy predicates referenced by hash; (d) applying model versions referenced by identifier; and (e) re-executing deterministic close tasks in the order specified by the manifest and task DAG. The replay engine then recomputes the stateRoot and validates that it matches the anchored stateRoot.

In some embodiments, a stateless verifier does not need access to raw events. Instead, the verifier can validate signatures, validate inclusion proofs, validate that the manifest references authorized rulepacks, and validate that reported aggregates match recomputed aggregates over disclosed digests. Selective disclosure may reveal only the subset of events relevant to a particular audit procedure.

In some embodiments, deterministic replay supports cross-party reconciliation. For example, a proof-of-netting receipt may include a list of external message correlation identifiers (e.g., end-to-end IDs) so that a verifier can confirm that a payment request message and a subsequent settlement message correspond to the same netting cycle. The verifier can then deterministically recompute the netting math and confirm that the residuals match observed settlements.

In some embodiments, deterministic replay supports dispute resolution and operational rollback. If an error is detected, the system can replay prior periods to identify the first divergence between computed digests and anchored digests, and can generate a remediation plan that includes corrective events and updated manifests, while preserving a full audit trail of changes.

This figure depicts a deterministic replay manifest and replay engine that reconstruct system behavior from receipts to produce audit-grade, repeatable results.

In one embodiment, the ReplayManifest pins: an ordered set (or DAG) of input receipts, referenced policies/templates (by content hash and version), execution environment descriptors (e.g., software build IDs, cryptographic suites, hardware attestation identifiers), and time-window constraints. The replay engine consumes the manifest and deterministically re-executes the claimed computation or control flow, producing a ReplayReceipt that includes recomputed state roots and intermediate checkpoints.

In some embodiments, the replay engine enforces determinism by applying explicit ordering and tie-breaking rules. For example, events are sorted by (i) logical time (e.g., HLC/Lamport), then (ii) source system ID, then (iii) monotonically increasing event sequence numbers, and finally (iv) a content hash as a deterministic tiebreaker. The ordering rules may be recorded in a DeterminismPolicyReceipt bound to the period_id.

In some embodiments, the replay engine isolates or records sources of nondeterminism, including random-number generation, external API responses, and concurrency interleavings. For example, the engine may record a nondeterminism log including random seeds, API response digests, and/or a deterministic thread schedule, enabling byte-for-byte replay of derived close outputs. Where strict replay is not required, the engine may compute a deterministic normalized result (e.g., rounding/quantization) and record a NormalizationPolicyReceipt specifying numerical precision and rounding mode.

In some embodiments, the execution environment is pinned using a compute environment digest that includes container image hashes, library versions, compiler flags, model weights/quantization configuration, and hardware feature flags (e.g., instruction set extensions). The environment digest may be attested by a trusted execution environment or hardware root of trust and included in the replay manifest so that a verifier can confirm that the same computational pipeline was used for the replay.

In some embodiments, deterministic replay supports partial replay and incremental recomputation. For example, the engine may use checkpoint receipts to avoid reprocessing unchanged event prefixes, thereby reducing compute cost and enabling near-real-time “rolling close” verification.

Replay can be scoped (e.g., per user, per AtomicGroup, per reporting period) and may produce a hierarchical replay tree so that auditors can validate a summary root quickly and drill down only when exceptions are detected.

In some embodiments, the deterministic replay manifest further pins numeric determinism parameters, including rounding mode, fixed-point scaling factors, ordering rules for commutative aggregates, and random seeds for any stochastic components, such that two independent implementations produce identical stateRoots for the same input receipt set.

In some embodiments, replay executes within a deterministic scheduler that enforces a canonical topological order of DAG tasks, stable tie-breaking, deterministic concurrency boundaries, and idempotent re-execution semantics; task-level outputs are committed via state commitment checkpoints that are hash-linked to period anchors.

### Close Dispersion Optimization: Load Metrics, Dispersion Score, and Scheduling

In some embodiments, the close dispersion orchestrator maintains one or more load metrics, including compute load metrics (e.g., CPU utilization, memory pressure, I/O bandwidth) and human capacity metrics (e.g., staff hours, overtime multipliers, queue backlogs, mean time to resolve exceptions).

In some embodiments, the orchestrator computes a dispersion score for a candidate schedule. The dispersion score may be based on a peak-to-mean ratio (or other dispersion statistic) computed over predicted load per operational period. For example, a lower peak-to-mean ratio indicates a more dispersed schedule. The score may also incorporate penalties for deadline risk, exception risk, or policy noncompliance.

In some embodiments, the orchestrator builds a scheduling problem where tasks are nodes with durations, dependencies, deadlines, and resource constraints. The orchestrator assigns tasks to operational periods and optionally to compute regions or human teams. The orchestrator may solve the scheduling problem using heuristics, constraint programming, integer programming, reinforcement learning, or hybrid techniques.

In some embodiments, the scheduling problem is expressed as a constraint optimization model with decision variables representing (i) assignment of micro-stage jobs to operational periods and/or capacity windows, and (ii) selection among alternative execution routes (e.g., alternative data sources, alternative compute tiers). Constraints may include dependency ordering (DAG), deadlines, jurisdictional blackout windows, data-availability cutoffs, and resource capabilities. The objective function may minimize a dispersion score (peak-to-mean load), minimize lateness penalties, and/or maximize a verified collective benefit metric.

In some embodiments, the orchestrator solves the scheduling problem using one or more solver classes, including mixed-integer linear programming (MILP), constraint programming (CP-SAT), heuristic search, and/or reinforcement learning policies with safety guardrails. The platform may record a SolverReceipt specifying solver type, version, termination criteria, and solution quality metrics, enabling deterministic replay of scheduling decisions.

In some embodiments, the orchestrator continuously re-optimizes as new events arrive, but does so in a receipt-native, auditable manner. For example, a ScheduleUpdateReceipt may record the delta between a prior schedule and an updated schedule, the triggering events (e.g., late-arriving ledger postings), and a justification predicate (e.g., dispersion improvement above a threshold or avoidance of a deadline miss).

In some embodiments, the orchestrator supports multi-tenant and multi-organization scheduling with fairness constraints (e.g., caps on deferral, proportional access to auditor capacity windows, or risk-budget quotas) and records fairness receipts that permit third parties to verify that the schedule did not systematically disadvantage a protected class of participants.

In some embodiments, the orchestrator proactively shifts close work ‘left’ in time by executing micro-stage tasks earlier, under a configured guardrail that ensures that the final close outputs are still produced by statutory deadlines. For example, reconciliations, confirmations, and control testing can be executed continuously or quarterly, so that year-end work is reduced to roll-forward and final evaluation.

In some embodiments, the orchestrator uses the time fabric to support internal operational calendars that differ from external reporting calendars. For example, if statutory reporting requires Gregorian month-end totals, the orchestrator can still schedule internal work by 4-4-5 operational periods and produce bridge receipts that map internal periods to statutory months and quarters.

In some embodiments, the orchestrator records the resulting schedule decisions in a run manifest and binds the schedule digest to the period boundary receipt. This provides a deterministic link between (i) the chosen dispersion schedule, (ii) the tasks executed, and (iii) the close outputs, enabling later verification that dispersion decisions were not manipulated after the fact.

### Worked Example: 4-4-5 Internal Operational Calendar With Anchored Period Closes

In an illustrative embodiment, an enterprise processes 120,000 ledger events in a statutory quarter. Under a conventional month-end workflow, compute and staffing loads cluster at the last day of each month and at the quarter end, producing a peak-to-mean compute utilization ratio of approximately 3.0 and a human overtime factor of approximately 2.2 relative to baseline.

In this embodiment, the enterprise configures an internal operational calendar view as a 4-4-5 cadence for the quarter (P1=4 weeks, P2=4 weeks, P3=5 weeks), while preserving statutory month-end and quarter-end reporting windows as external views. The time fabric labels each event with both a statutory Gregorian label and an internal 4-4-5 label.

At each internal period boundary, the platform generates a PeriodBoundaryReceipt that binds (i) the internal period_id, (ii) the internal period start and end, (iii) the calendar configuration hash, and (iv) a stateRoot computed over canonicalized state objects and included events. The receipt is signed and includes a trusted time anchor. A bridge record maps internal period endpoints to statutory month-end boundaries.

The close dispersion orchestrator decomposes quarter-close tasks (reconciliations, confirmations, audit sampling, and control testing) into micro-stage tasks. Some micro-stage tasks are executed at the end of P1 and P2, rather than deferring all work to the end of P3. The orchestrator also reserves one or more audit capacity windows in off-peak weeks to execute procedures earlier.

After a quarter of operation, the platform measures that the peak-to-mean compute utilization ratio decreases from approximately 3.0 to approximately 1.6, and that the overtime factor decreases from approximately 2.2 to approximately 1.3. In some embodiments, settlement retry rates also decrease (e.g., by approximately 45%) due to earlier reconciliation and pre-authorization aligned to period anchors. The measured improvements are emitted as receiptized metrics, each bound to the relevant run manifests and period anchors.

In some embodiments, the platform mints surplus credits associated with measured reductions (e.g., reduced overtime costs, reduced retry costs, reduced cloud burst costs). The surplus credits can be redistributed according to benefit-sharing parameters or used to prefund future cycles (e.g., prefunding a float for employee benefit capture mechanisms) while maintaining an auditable trail.

### Worked Example: Auditor Capacity Windows and PvP-Like Booking

In an illustrative embodiment, an audit firm publishes availability windows throughout a year, each window represented as a capacity token. Each capacity token may specify role composition (e.g., partner hours, manager hours, staff hours), permitted industries or controls, pricing bands, and a time interval label in the time fabric. The audit firm may disclose only limited attributes before commitment.

A client organization uses the close dispersion orchestrator to reserve capacity tokens in advance. Reservation decisions are recorded in booking receipts. The system treats the reserved windows as hard constraints, similar to PvP-like mutual commitments: the client commits to provide evidence packages by specified dates, and the auditor commits to deliver procedures within the reserved windows.

During execution, the client produces interim evidence packages (e.g., for Q1, Q2, Q3) and anchors them with period boundary receipts. The auditor performs procedures on a rolling basis within reserved windows, and issues procedure receipts that reference the evidence packages and the relevant manifests. By year-end, final audit work is reduced to roll-forward tasks and final evaluations.

If a permitted timing adjustment is performed (e.g., early inventory count with later roll-forward), the system emits a TemporalSwapReceipt that documents the substitution, the roll-forward assumptions, the variance thresholds, and the final evaluation. This preserves audit integrity while allowing the schedule to be dispersed away from peak periods.

### Continuous Audit Streams and Control Testing

In some embodiments, the system supports continuous audit streams by ingesting control signals (e.g., system logs, access events, control KPIs) and executing automated control tests as micro-stage tasks. Each test may emit a test receipt with a time anchor, and exceptions may emit exception receipts, allowing auditors to address issues when they arise.

In some embodiments, provenance-gated ingestion is used. For example, an event stream may be accepted only if accompanied by a source signature, a secure log digest, or an attestation. Provenance receipts bind ingested data to the source attestation. This supports stateless verification that evidence was not tampered with.

In some embodiments, outbound workpapers and audit reports are accompanied by content credentials that link them to the receipts and manifests that support their conclusions. This makes the audit file replayable: a verifier can check that each conclusion is backed by a set of anchored procedures.

### Integration With Netting, Settlement Rails, and Transaction Consolidation

In some embodiments, close dispersion is integrated with settlement compression. For example, pre-offset authorizations are aligned to period anchors so that netting sets can be computed and authorized earlier in the cycle. By dispersing reconciliation and authorization tasks, the system reduces retry rates and reduces last-minute exception handling.

In some embodiments, each settlement instruction includes a correlation identifier that links it to the proof-of-netting receipt for the cycle. Correlation identifiers may be propagated across messaging standards (e.g., in structured remittance fields or end-to-end identifiers). Deterministic replay manifests may include these identifiers, enabling cross-rail reconciliation without manual matching.

In some embodiments, the correlation identifier comprises one or more standardized payment or message identifiers, including ISO 20022 fields such as EndToEndId, InstructionId, or MsgId, and/or a Unique End-to-end Transaction Reference (UETR) carried through payment-rail confirmations. The platform binds these identifiers into TransactionReceipt and SettlementManifest structures (or references them via hashes) so that external confirmations can be deterministically reconciled to internal receipts, netting vectors, and period-close states during replay.

In some embodiments, the correlation identifier includes, maps to, or is derived from ISO 20022 identifiers. For example, for a credit transfer message, the system can populate and preserve an EndToEndId field in the payment identification structure and, where available, preserve a Unique End-to-end Transaction Reference (UETR) used in cross-border tracking. The correlation identifiers are stored in settlement receipts and are also referenced by run manifests and netting receipts such that a replay can deterministically reconcile ledger entries to external bank confirmations or network acknowledgements.

In some embodiments, where legal set-off is not permitted, the system executes paired gross legs and includes a no-net justification code in the proof-of-netting receipt. The paired legs remain linked for replay and audit, but the execution preserves compliance constraints.

In some embodiments, the system maintains a unified reconciliation graph that links event digests, receipts, and external message confirmations. The reconciliation graph enables rapid identification of mismatches and supports automated remediation tasks scheduled under the close dispersion orchestrator.

This adapter bridges the ledger's token rails and traditional banking rails with strong auditability. When settling a multilateral net, the orchestrator prepares both the token transfers and the ISO 20022 bank payments under a two-phase commit. If all prepare successfully, it commits all; if any fail, it aborts and rolls back. Upon completion, the system emits a Settlement Manifest-a JSON document containing fields like “atomic_group_id”, hashes of inputs/outputs, lists of token_receipts and bank_receipts, and the operator/auditor signatures. Each payment instruction includes an EndToEndId so that related transfers (e.g. a Request-for-Payment and its resulting credit transfer) can be correlated. In fact, the platform carries the ISO 20022 EndToEndId (and UETR for cross-border flows) through to the ledger receipts. This means that every transfer leg across rails is linked by a common ID, and the Proof-of-Netting (PoN) receipts log these IDs for deterministic reconciliation. In effect, the figure would depict swimlanes for token vs. bank legs (with pacs. 008/013 messages) converging into an atomic group, and the resulting Settlement Manifest JSON summarizing the outcome, providing cryptographic proof of atomicity and cross-rail correlation.

### Additional Dependent-Level Embodiments: Plan Years, Tax Years, and Policy Cutovers

In some embodiments, time fabric period anchors are used to manage plan-year and tax-year boundaries, including open enrollment windows, mid-year qualifying events, and regulatory threshold resets. The system can schedule cutover tasks (e.g., coverage changes, deduction changes, filing cycles) as micro-stages and anchor them for replay.

In some embodiments, a plan-year cutover emits a cutover receipt that binds the plan parameters, the effective date, and the applied safe harbor method. If an affordability parameter changes across years, the system recomputes contributions and emits updated payroll delta receipts before the plan-year start, with deterministic replay support.

In some embodiments, the system supports 52/53-week fiscal year variants, ISO week year variants, and other non-standard time schemas by expressing them as calendar configurations in the time fabric. Bridge receipts map operational periods to statutory periods so that external reporting remains compliant while internal work is dispersed.

### Additional Technical Effects and Patentability Posture

In some embodiments, the time fabric and close dispersion techniques improve computer operation by reducing peak resource contention, reducing redundant computations, and enabling deterministic replay of distributed processes. These improvements are realized through specific data structures (period boundary receipts, deterministic replay manifests, stateRoots) and scheduling routines that are not merely generic business logic.

In some embodiments, the receipt-native architecture also improves security and integrity by reducing mutable state, reducing manual intervention points, and providing tamper-evident proofs of period cutoffs, schedule decisions, and close outputs.

In some embodiments, the stable independent-claim kernel supports repeatability across industries, while dependent-claim clusters express vertical specifics (e.g., accounting close, payroll and benefits, ESPP and retirement, insurance pooling, subscription lifecycle), thereby enabling a scalable family strategy with controlled restriction risk.

In some embodiments, the described techniques improve operation of a computer system by reducing reconciliation and recomputation workload. For example, by emitting deterministic replay manifests and period boundary receipts, a verifier can validate derived outputs using a bounded set of receipts and inclusion proofs, rather than reprocessing entire raw datasets. This reduces CPU cycles, I/O bandwidth, and memory pressure during audits and during post-close investigations, and reduces contention during peak close windows.

In some embodiments, the described techniques improve networked and distributed computing by enabling deterministic coordination across asynchronous systems. For example, the atomic booking protocol and booking receipts provide a machine-verifiable coordination artifact for distributed scheduling, reducing race conditions, double-booking, and inconsistent states across scheduling, execution, and settlement subsystems.

In some embodiments, the time fabric provides a technical improvement in time synchronization and ordering for distributed event processing. By anchoring operational periods to trusted time attestations and/or secure time synchronization and by binding time-source measurements and attestation reports into receipts, the system reduces susceptibility to time-based attacks and improves integrity of event ordering used in downstream deterministic processing.

In some embodiments, the disclosed techniques constitute a practical application that integrates rulepacks, models, and receipt-native records into a specific technological environment (distributed close orchestration, auditing, and reconciliation). The claims and embodiments are directed to specific data structures, cryptographic commitments, and scheduling routines that yield concrete technical effects including improved auditability, reduced exceptions, reduced latency to detect anomalies, and improved integrity of distributed processing. The disclosure is not intended to preempt all ways of performing accounting, auditing, scheduling, or optimization; rather, it provides specific implementations with verifiable receipts and deterministic replay.

Amendment-ready technical hooks (non-limiting). The specification describes a set of concrete technical mechanisms that can be used, individually or in combinations, to amend claims or to draft continuation claims while staying within the disclosed architecture. Non-limiting examples include: (i) deterministic event ordering using hybrid logical clocks and event_index tiebreakers; (ii) period boundary receipts bound to trusted time-stamp tokens; (iii) secure time synchronization using Network Time Security for NTP and/or authenticated Precision Time Protocol; (iv) stateRoot computation using Merkle roots or other accumulator structures; (v) schedule_hash and atomic booking receipts for auditor-capacity windows with two-phase commit; (vi) witness bundles carrying inclusion proofs for stateless verification; (vii) remote attestation of trusted execution environments or signing modules; (viii) proof-carrying compression of receipt subgraphs; and (ix) redactable ledger structures with public redaction proofs.

In some embodiments, technical features described herein can be claimed in a domain-agnostic form (e.g., distributed computing close of any stateful process) while domain-specific applications (accounting close, payroll close, benefits plan-year reconciliation, settlement rails) are expressed as dependent limitations, thereby reducing restriction risk and improving enforceability against systems that adopt similar deterministic audit fabrics.

### Asset Parcelization, Wrapper States, and Hybrid Asset-Class Handling

In some embodiments, the system represents assets and entitlements at a granular level using an AssetParcel abstraction. An AssetParcel is a smallest unit of utility that the system schedules, reallocates, rewraps, or otherwise optimizes. An AssetParcel may correspond to, for example, a time slice of occupancy, a number of vehicle miles, a portion of a payroll cycle, a fraction of equity, a unit of insurance risk exposure, or a micro-task in a worker schedule.

In some embodiments, each AssetParcel is recorded via an AssetParcelReceipt that includes at least: {asset_identifier, parcel_identifier, quantity_dimension, jurisdictional_context_ids[], legal_wrapper_candidate_set[], wrapper_state, usage_state, timestamps, signature}. The wrapper_state indicates the current or pending wrapper that holds title or ownership rights; the usage_state indicates current or pending usage agreements or access rights.

In some embodiments, the platform treats a ‘hybrid asset class’ as a set of parcel states that may vary over time and context. For example, the same underlying asset may be personal property for some periods, business property for other periods, or a nonprofit/foundation-owned asset for certain parcels, subject to policy constraints. The platform can therefore classify and reclassify parcels in a controlled way while preserving a deterministically replayable audit trail.

In some embodiments, wrapper selection is performed by an Asset Wrapper Engine coupled to a policy lattice engine. The policy lattice encodes jurisdictional rulepacks and thresholds (e.g., labor classification tests, benefits eligibility constraints, tax constraints, nonprofit governance constraints, regulatory capital constraints). For a given parcel, the engine evaluates each wrapper candidate under the lattice and records a WrapperEvaluationReceipt that includes test results and a machine-verifiable explanation graph linking to the applied rulepack hashes and predicates.

In some embodiments, where one or more wrapper candidates satisfy mandatory constraints, the engine selects a wrapper based on an objective function that includes surplus, aggregate utility, and compliance risk. A WrapperBindingReceipt records the selected wrapper for the parcel and binds the decision to time anchors and manifests. Where conditions change, the engine may emit WrapperRebindingReceipts that shift parcels between wrappers while preserving usage access and maintaining deterministic replay.

In some embodiments, parcelization and wrapper state handling are integrated with the time fabric. For example, parcels may be defined over time intervals (e.g., a weekend, a payroll day, a plan-year month), and the time fabric provides canonical time labeling and period anchors so that wrapper changes and usage agreements can be audited against the correct time windows.

### Disintermediation of Human and Institutional Middlemen via Receipt-Native Execution

In some embodiments, the system reduces or eliminates reliance on intermediaries by encoding policy constraints, schedule commitments, and settlement compression directly into machine-executable rulepacks and deterministic manifests. Historically, intermediaries (e.g., brokers, agents, reconciliation teams, coordinators) exist to bridge non-deterministic system boundaries, to reconcile mismatched timebases, and to create trust through manual review.

In some embodiments, the receipt-native architecture replaces manual trust with verifiable computation artifacts. For example, instead of an intermediary certifying that a period close was properly performed, the system produces anchored period boundary receipts and deterministic replay manifests that allow a verifier to recompute and validate close outputs. Instead of intermediaries manually matching payment legs, the system emits proof-of-netting receipts with correlation identifiers that enable deterministic cross-rail reconciliation.

In some embodiments, the system reduces decision errors by transforming complex choices into constrained optimization problems whose outcomes are made safe by design. For example, where a human might otherwise act as a ‘middleman’ who chooses among suboptimal or biased options, the system encodes constraints (legal, policy, risk envelopes) and automatically selects an outcome that is both feasible and optimal under the objective function, emitting receipts that document the decision inputs, constraints, and outputs.

In some embodiments, disintermediation is achieved not by removing accountability, but by moving accountability into verifiable artifacts (receipts, anchors, manifests) that can be inspected by auditors, regulators, and counterparties. This supports scalable coordination across many participants and industries while reducing transaction counts and reducing frictional costs.

### Regenerative and Surplus Allocation Variants (Optional)

In some embodiments, measured efficiency improvements (e.g., reduced overtime costs, reduced cloud burst costs, reduced retry costs, reduced transaction fees) are treated as surplus that can be accounted for and allocated under configurable rules. Surplus allocation may be performed at parcel granularity and may be recorded in surplus receipts that link to the underlying run manifests and measurement receipts.

In some embodiments, surplus can be allocated to users, to pooled reserves, to underwriting buffers, to subsidy pools, or to designated social-good objectives, while preserving an auditable trail. In some embodiments, surplus allocation rules are expressed as policy rulepacks and are bound to time anchors so that later verifiers can confirm that surplus was allocated under the correct rule version and period.

What is claimed is:

1. A system for allocating asset ownership for maximized collective economic benefit, the system comprising:
at least one computer system comprising a processor and a memory storing executable instructions, wherein the processor executes the instructions to:
receive information about a user and an asset used or to be used by the user;
store neural-network weights as a 32-bit floating-point variable;
store neural-network activations as a 32-bit floating-point variable;
statically quantize neural-network weights and neural-network activations as 8-bit integers, wherein the neural-network weights are quantized to reduce storage footprint;
ingest asset-utilization transaction data containing historical sale, lease, usage and user-profile records for the user-asset pair; and
retrieve supplemental historical datasets of economic outcomes and user demographics;
utilize an application-specific integrated circuit (ASIC) for an artificial neural network connected to the memory, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein at least one hidden input intermediate layer(s) contains a plurality of neurons, each performing weighted calculations to identify patterns, correlations, and relationships within the input data, wherein the hidden layer(s) uses activation functions comprising ReLU (Rectified Linear Unit) and sigmoid functions to determine non-linear relationships; a plurality of synaptic circuits, each synaptic circuit storing a synaptic weight and coupling at least two neurons; and circuitry operable to execute a functionally invariant path (FIP) algorithm that updates network weights along differential-geometry paths so as to preserve learned behavior while increasing sparsity wherein the array is configured to analyze said business sale transaction information, asset usage, ownership structures, and economic outcomes, trained on historical datasets including a parameter for each of business sale transaction information, asset usage, ownership structures, and economic outcomes, wherein the AI/ML categorization engine makes a prediction regarding the most efficient use(s) of an asset;
wherein during the training process the ASIC uses supervised learning, where labeled datasets containing known inputs and desired outputs are fed into the network; the neural network adjusts its internal weights using a backpropagation algorithm, which minimizes the difference between the network's predictions and the actual outcomes as measured by a mean squared error loss function and the ASIC iteratively refines its predictions until the error rate falls below a predefined threshold, ensuring that the network can make accurate predictions on new, unseen data;
wherein the ASIC is further configured to:
execute a artificial intelligence machine learning categorization engine on the asset-utilization transaction data and output a predicted most-efficient-use vector for the asset;
compare the ASIC output to the user's declared or observed usage pattern and flag in the data structure a projected differential meeting or exceeding a predefined threshold ownership inefficiency;
issue a query to an ownership-entity database and return a ranked candidate list of specialized entities;
compute the maximum function output value of expected collective economic benefit across the candidate list and select the top-ranked entity;
encode a parameter for a transaction execution that transfers legal title to the selected entity while preserving usage rights for the user, wherein encoding the transfer and preservation of usage rights comprises: generating, in memory, a conveyance record designating the selected ownership entity as owner of the asset and a usage-agreement record granting the user possession or access under a lease, rental, or long-term usage agreement; executing the conveyance and usage agreement; storing the executed records in a database of assets, ownership entities, and users; and calculating and storing a benefit-sharing parameter to be redistributed to the user; and
wherein the memory further stores instructions that cause the system to:
migrate dataset shards between distributed memory devices in different geospatial data centers whenever a latency-or-cost heuristic is met to sustain parallel low-latency access, wherein migrating dataset shards between geospatial data centers comprises caching frequently accessed data and prefetching anticipated data to reduce access latency;
repeat, using the ASIC, an evaluate and optimize process to detect that re-titling of an asset would deliver an improvement above a set threshold and invoke another title-transfer routine that assigns the asset to a newly selected entity without interrupting user access;
apply the FIP algorithm to newly accumulated asset-utilization transaction data so as to refine prediction accuracy while preserving prior knowledge; and
dispatch an electronic alert to the user confirming continuity of usage following an ownership reassignment.

2. The system of claim 1, wherein the memory further stores executable instructions that, when executed by the processor, cause the processor to: by a time-fabric module, normalize timestamps associated with at least the asset-utilization transaction data and the conveyance record into a plurality of synchronized calendar labels, the plurality of synchronized calendar labels including at least one Gregorian calendar label and at least one non-Gregorian operational calendar label; and
deterministically generate an operational period identifier (period_id) for an operational period based at least on the synchronized calendar labels and a calendar-configuration hash.

3. The system of claim 2, wherein the memory further stores executable instructions that cause the processor to: at an end boundary of the operational period, generate a period boundary receipt binding: (i) the period_id, (ii) a period start timestamp and a period end timestamp, (iii) the calendar-configuration hash, (iv) a stateRoot computed over canonicalized state records of at least one database storing transaction receipt objects and executed records, (v) a previousCheckpointId referencing at least one prior period boundary receipt or checkpoint receipt, and (vi) a trusted timestamp token; and store the period boundary receipt in an append-only event log.

4. The system of claim 3, wherein the memory further stores executable instructions that cause the processor to: generate a deterministic replay manifest referencing the period boundary receipt and including (i) input digests of the asset-utilization transaction data used to generate a period close output and (ii) version identifiers for at least one of a rulepack, a model_hash, or a calendar configuration, wherein the deterministic replay manifest enables deterministic re-execution to reproduce the period close output.

5. The system of claim 3, wherein the memory further stores executable instructions that cause the processor to: generate a period close output for external reporting by executing a close-processing workflow partitioned into micro-stage jobs; schedule execution of the micro-stage jobs across compute nodes based at least on a dispersion score that measures peak-to-mean utilization of at least one of CPU, memory, or I/O resources; and cryptographically bind the period close output to the period boundary receipt to enable verifiable deterministic replay.

6. The system of claim 2, wherein the at least one non-Gregorian operational calendar label comprises at least one of: a 4-4-5 retail calendar label, a 5-4-4 retail calendar label, a 4-5-4 retail calendar label, a 52/53-week fiscal year label, an International Fixed calendar label, a lunar calendar label, or a custom operational calendar label.

7. The system of claim 3, wherein the period boundary receipt comprises a structured object including fields comprising: period_id, calendarConfigurationHash, periodStart, periodEnd, stateRoot, previousCheckpointId, and signature, wherein the signature is generated using a private key stored in a hardware security module (HSM) or a trusted execution environment (TEE).

8. The system of claim 3, wherein the trusted timestamp token is requested from, or validated against, a trusted time source comprising at least one of: (i) a secure Network Time Security (NTS) server, (ii) a Precision Time Protocol (PTP) grandmaster, or (iii) an RFC 3161 time-stamping authority, and wherein the period boundary receipt includes, or references, an RFC 3161 time-stamp token.

9. The system of claim 3, wherein generating the stateRoot comprises computing a Merkle tree root hash over the transaction receipt objects and the executed records, and generating a compact state witness enabling verification of membership of at least one transaction receipt object in the Merkle tree without access to a full copy of the at least one database.

10. The system of claim 5, wherein the memory further stores executable instructions that cause the processor to: reserve audit capacity windows for the close-processing workflow by executing an atomic scheduling protocol that finalizes a set of calendar slots, and generate an audit reservation receipt binding the reserved set of calendar slots to the period_id and a schedule hash.

11. The system of claim 3, wherein the transaction receipt objects are stored in the append-only event log and each transaction receipt object includes a correlation identifier that correlates the conveyance record, the usage-agreement record, and one or more external-system transaction identifiers, and wherein the correlation identifier comprises at least one of an ISO 20022 EndToEndId or a SWIFT gpi UETR.

12. A computer-implemented method for allocating asset ownership for maximized collective economic benefit, the method comprising: (a) receiving, at at least one computer system comprising a processor and a memory, information about a user and an asset used or to be used by the user; (b) storing neural-network weights and neural-network activations in 32-bit floating-point format; (c) statically quantizing the neural-network weights and the neural-network activations as 8-bit integers; (d) ingesting asset-utilization transaction data containing historical sale, lease, usage and user-profile records for a user-asset pair, and retrieving supplemental historical datasets of economic outcomes and user demographics; (e) utilizing an application-specific integrated circuit (ASIC) for an artificial neural network connected to the memory, the ASIC comprising a plurality of neurons organized in an array and a plurality of synaptic circuits storing synaptic weights, wherein during a training process the ASIC uses supervised learning with backpropagation to minimize a mean squared error loss function until an error rate falls below a predefined threshold, and executing a functionally invariant path (FIP) algorithm that preserves learned behavior while increasing sparsity; (f) executing, using the ASIC, an artificial intelligence/machine-learning (AI/ML) categorization engine on the asset-utilization transaction data to output a predicted most-efficient-use vector for the asset; (g) comparing the predicted most-efficient-use vector to the user's declared or observed usage pattern and flagging a projected differential meeting or exceeding a predefined threshold ownership inefficiency; (h) querying an ownership-entity database to return a ranked candidate list of specialized entities, computing the maximum function output value of expected collective economic benefit across the ranked candidate list, and selecting a top-ranked entity; (i) migrating dataset shards between distributed memory devices in different geospatial data centers whenever a latency-or-cost heuristic is met, including caching frequently accessed data and prefetching anticipated data; (j) encoding a parameter for a transaction execution that transfers legal title to the selected entity while preserving usage rights for the user by generating a conveyance record and a usage-agreement record, executing the conveyance record and the usage-agreement record, storing executed records in a database of assets, ownership entities, and users, and calculating and storing a benefit-sharing parameter to be redistributed to the user; (k) repeating an evaluate and optimize process to detect that re-titling of the asset would deliver an improvement above a set threshold and invoking another title-transfer routine that assigns the asset to a newly selected entity without interrupting user access, applying the FIP algorithm to newly accumulated asset-utilization transaction data to refine prediction accuracy while preserving prior knowledge; (l) dispatching an electronic alert to the user confirming continuity of usage following an ownership reassignment; (m) by a time-fabric module, normalizing timestamps associated with at least the asset-utilization transaction data and the conveyance record into synchronized calendar labels including at least one Gregorian calendar label and at least one non-Gregorian operational calendar label, and deterministically generating an operational period identifier (period_id) based at least on the synchronized calendar labels and a calendar-configuration hash; and (n) at an end boundary of an operational period, generating a period boundary receipt and a deterministic replay manifest and storing the period boundary receipt in an append-only event log to enable deterministic replay of a period close output.

13. The method of claim 12, wherein the at least one non-Gregorian operational calendar label comprises at least one of: a 4-4-5 retail calendar label, a 5-4-4 retail calendar label, a 4-5-4 retail calendar label, a 52/53-week fiscal year label, an International Fixed calendar label, a lunar calendar label, or a custom operational calendar label.

14. The method of claim 12, wherein generating the period boundary receipt comprises computing a Merkle tree root hash as the stateRoot over transaction receipt objects and executed records and generating a compact state witness enabling verification of membership of at least one transaction receipt object in the Merkle tree without access to a full copy of the database.

15. The method of claim 12, further comprising: generating a period close output for external reporting by executing a close-processing workflow partitioned into micro-stage jobs; scheduling execution of the micro-stage jobs across compute nodes based at least on a dispersion score that measures peak-to-mean utilization of at least one of CPU, memory, or I/O resources; reserving audit capacity windows by executing an atomic scheduling protocol that finalizes a set of calendar slots;
generating an audit reservation receipt binding the reserved set of calendar slots to the period_id and a schedule hash; and cryptographically binding the period close output to the period boundary receipt to enable verifiable deterministic replay.

16. A non-transitory computer-readable medium storing instructions that, when executed by at least one processor, cause a computing system to perform the method of claim 12.

17. The non-transitory computer-readable medium of claim 16, wherein the instructions further cause the computing system to: generate the period boundary receipt as a structured object including fields comprising: period_id, calendarConfigurationHash, periodStart, periodEnd, stateRoot, previousCheckpointId, and signature, wherein the signature is generated using a private key stored in a hardware security module (HSM) or a trusted execution environment (TEE).

18. The non-transitory computer-readable medium of claim 16, wherein the instructions further cause the computing system to request or validate a trusted timestamp token from a trusted time source comprising at least one of (i) a secure Network Time Security (NTS) server, (ii) a Precision Time Protocol (PTP) grandmaster, or (iii) an RFC 3161 time-stamping authority, and include, or reference, an RFC 3161 time-stamp token in the period boundary receipt.

19. The non-transitory computer-readable medium of claim 16, wherein the instructions further cause the computing system to compute the stateRoot as a Merkle tree root hash over transaction receipt objects and executed records and generate a compact state witness enabling verification of membership of at least one transaction receipt object in the Merkle tree without access to a full copy of the database.

20. The non-transitory computer-readable medium of claim 16, wherein the instructions further cause the computing system to reserve audit capacity windows for the close-processing workflow by executing an atomic scheduling protocol that finalizes a set of calendar slots and generate an audit reservation receipt binding the reserved set of calendar slots to the period_id and a schedule hash.
